(19) United States
(12) Patent Application Publication
(10) Pub. No.: US 2011/0194015 A1
(43) Pub. Date: Aug. 11, 2011

(54) Zoom lens and imaging apparatus

(75) Inventor: Fumikazu Kanetaka, Chiba (JP)

(73) Assignee: Sony Corporation, Tokyo (JP)

(21) Appl. No.: 12/929,468

(22) Filed: Jan. 27, 2011

(30) Foreign Application Priority Data
Feb. 5, 2010 (JP) 2010-024212

(51) Int. Cl. G02B 15/14; H04N 5/232

(52) U.S. Cl. 348/345; 359/683; 348/E05.055

(57) ABSTRACT

A zoom lens includes: a first lens group including a reflection member that deflects an optical path by 90 degrees and having positive refracting power; a second lens group having negative refracting power; a third lens group having positive refracting power; at least one lens group having negative refracting power and at least one lens group having positive refracting power disposed as a fourth lens group and the following lens groups, the first to third lens groups and the fourth and following lens groups arranged in this order from an object side toward an image side; and an aperture diaphragm disposed in the vicinity of the third lens group, wherein in zooming from a wide angle end state to a telescopic end state, the first lens group is fixed, the second lens group is moved toward the image side, and the fourth lens group is moved toward the object side, and the zoom lens satisfies the following conditional equation

1<(R1B+R21A)/(R1B−R21A)<20.

### BACKGROUND OF THE INVENTION

1. Field of the Invention

The present invention relates to a zoom lens and an imaging apparatus, and particularly to a technical field of a zoom lens and an imaging apparatus preferably used in a digital video camcorder, a digital still camera, and other electronic cameras and characterized by a compact size, a high variable power ratio, and high performance.

2. Description of the Related Art

In recent years, a digital video camcorder, a digital still camera, and other similar apparatus using a CCD (Charge Coupled Device), a CMOS (Complementary Metal-Oxide Semiconductor) device, or any other solid-state imaging device have rapidly come into wide use. As such digital cameras and other similar apparatus have come into wide use, there is a strong demand particularly on wide-angle, high variable power ratio zoom lenses suitable for a large number of pixels. There is also a strong demand on size reduction, in particular, thickness reduction.

In view of the demands described above, a prism is disposed in a first lens group located in an optical system in a position closest to an object so that the size and thickness of the first lens group is reduced in the optical axis direction (see JP-A-2005-195757 and JP-A-2007-3598, for example).

The zoom lens described in JP-A-2005-195757 is formed of six lens groups respectively having positive, negative, positive, positive, negative, and positive refracting power, specifically, a first lens group having positive refracting power, a second lens group having negative refracting power, a third lens group having positive refracting power, a fourth lens group having positive refracting power, a fifth lens group having negative refracting power, and a sixth lens group having positive refracting power arranged in this order from the object side toward the image side.

In the zoom lens described in JP-A-2005-195757, a high variable power ratio of approximately five at the maximum is achieved by moving the second, fourth, and sixth lens groups to perform zooming.

The zoom lens described in JP-A-2007-3598 is formed of five lens groups respectively having positive, negative, positive, negative, and positive refracting power, specifically, a first lens group having positive refracting power, a second lens group having negative refracting power, a third lens group having positive refracting power, a fourth lens group having negative refracting power, and a fifth lens group having positive refracting power arranged in this order from the object side toward the image side.

In the zoom lens described in JP-A-2007-3598, a variable power ratio of approximately three is achieved by moving the second, third, and fifth lens groups to perform zooming.

### SUMMARY OF THE INVENTION

In the zoom lens described in JP-A-2005-195757, however, the sixth lens group, which is moved toward the object side during zooming operation, does not greatly contribute to change in magnification, and the second lens group carries a relatively large burden of changing the magnification. Increasing the amount of movement of the second lens group to further increase the variable power ratio causes off-axis light rays incident on the first lens group to likely shift away from the optical axis at a wide angle end, resulting in difficulty reducing the diameters of the lenses in the first lens group and hence no reduction in size of the zoom lens. Further, to enlarge the angle of view, the fact that the angle of view at the wide angle end is approximately 60 degrees inevitably causes increase in size of the first lens group.

In the zoom lens described in JP-A-2007-3598, in which the second and third lens groups are primarily responsible for change in magnification, to further increase the higher variable power ratio, it is necessary to increase the amount of movement of the second and third lens groups, resulting in difficulty reducing the size of the optical system. Further, to increase the variable power ratio while keeping the size of the zoom lens compact, it is necessary to increase the refracting power of the second and third lens groups, resulting in difficulty reducing the amount of change in aberrations induced by zooming operation, and to further enlarge the angle of view, it is difficult to correct off-axis aberrations at the wide angle end.

It is therefore desirable to provide a zoom lens and an imaging apparatus that solve the problems described above and achieve reduction in size, increase in variable power ratio, and enhancement of performance while ensuring a wide angle of view.

According to an embodiment of the invention, there is provided a zoom lens including a first lens group including a reflection member that deflects an optical path by 90 degrees and having positive refracting power, a second lens group having negative refracting power, a third lens group having positive refracting power, and at least one lens group having negative refracting power and at least one lens group having positive refracting power disposed as a fourth lens group and the following lens groups. The first to third lens groups and the fourth and following lens groups are arranged in this order from the object side toward the image side. The zoom lens further includes an aperture diaphragm disposed in the vicinity of the third lens group, and the lens groups described above are moved as follows when zooming is performed from a wide angle end state to a telescopic end state: The first lens group is fixed; the second lens group is moved toward the image side; and the fourth lens group is moved toward the object side. The zoom lens satisfies the following conditional equation (1):

1<(R1B+R21A)/(R1B−R21A)<20 (1)

where R1B represents the radius of curvature of the surface closest to an image plane in the first lens group, and R21A represents the radius of curvature of the surface closest to an object plane in the second lens group.

The zoom lens therefore includes at least one lens group having positive refracting power and at least one lens group having negative refracting power on the object and image sides of the aperture diaphragm, respectively.

When the zoom lens satisfies the conditional equation (1), the shape of an air lens between the first and second lens groups at the wide angle end has an appropriate shape.

In the zoom lens described above, the first lens group is desirably formed of a negative meniscus lens with a convex surface facing the object side, the reflection member, and a positive lens arranged in this order from the object side toward the image side.

The entrance pupil position becomes closer to the surface of the first lens group on which light is incident by configuring the first lens group as described above.

In the zoom lens described above, the second lens group is desirably formed of a first portion group and a second portion group arranged in this order from the object side toward the image side. It is also desirable that the first portion group is formed of a negative biconcave lens and the second portion group is formed of one or two lenses including a positive lens.

Aberrations induced in the second lens group are suppressed and the thickness of the second lens group in the optical axis direction has an appropriate value by configuring the second lens group as described above.

The zoom lens described above desirably satisfies the following conditional equation (2):

−10<(R21B+R22A)/(R21B−R22A)<0 (2)

where R21B represents the radius of curvature of the surface closest to the image plane in the first portion group in the second lens group, and R22A represents the radius of curvature of the surface closest to the object plane in the second portion group in the second lens group.

When the zoom lens satisfies the conditional equation (2), the shape of an air lens between the first and second portion groups in the second lens group has an appropriate shape.

The zoom lens described above desirably satisfies the following conditional equation (3):

0<D12t/ft<0.4 (3)

where D12t represents the distance from the apex of the surface closest to the image plane in the first lens group to the apex of the surface closest to the object plane in the second lens group at the telescopic end, and ft represents the focal length of the whole lens system at the telescopic end.

When the zoom lens satisfies the conditional equation (3), the distance between the first and second lens groups at the telescopic end has an appropriate value.

In the zoom lens described above, the lens group disposed in a position closest to the image plane desirably has positive refracting power.

When the lens group disposed in a position closest to the image plane has positive refracting power, the exit pupil position shifts away from the image plane.

In the zoom lens described above, a biconvex lens is desirably disposed in the third lens group in a position closest to the object plane.

When a biconvex lens is disposed in the third lens group in a position closest to the object plane, spherical aberrations are corrected in a satisfactory manner across the entire zooming area.

In the zoom lens described above, the fourth lens group is desirably formed of a single lens or a doublet.

When the fourth lens group is formed of a single lens or a doublet, the fourth lens group, which is a movable group, is reduced in size.

In the zoom lens described above, it is desirable to move any one of the lens groups downstream of the third lens group but other than the fourth lens group in the optical axis direction during zooming operation.

When any one of the lens group downstream of the third lens group but other than the fourth lens group is moved in the optical axis direction during zooming operation, three movable lens groups share the burden of changing the magnification.

The zoom lens described above desirably satisfies the following conditional equation (4):

0.1<|f21/(fw×ft)^{1/2}|<1.5 (4)

where f21 represents the focal length of the first portion group in the second lens group, fw represents the focal length of the whole lens system at the wide angle end, and ft represents the focal length of the whole lens system at the telescopic end.

When the zoom lens satisfies the conditional equation (4), the refracting power of the first portion group in the second lens group has an appropriate value.

The zoom lens described above desirably satisfies the following conditional equation (5):

0.1<|f12/(fw×ft)^{1/2}|<1.5 (5)

where f12 represents the focal length of the positive lens disposed on the image side of the reflection member in the first lens group, fw represents the focal length of the whole lens system at the wide angle end, and ft represents the focal length of the whole lens system at the telescopic end.

When the zoom lens satisfies the conditional equation (5), the refracting power of the positive lens disposed on the image side of the reflection member in the first lens group has an appropriate value.

The zoom lens described above desirably satisfies the following conditional equation (6):

0.5<|f11/(fw×ft)^{1/2}1<2.0 (6)

where f11 represents the focal length of the negative meniscus lens disposed on the object side of the reflection member in the first lens group, fw represents the focal length of the whole lens system at the wide angle end, and ft represents the focal length of the whole lens system at the telescopic end.

When the zoom lens satisfies the conditional equation (6), the refracting power of the negative meniscus disposed on the object side of the reflection member in the first lens group has an appropriate value.

According to another embodiment of the invention, there is provided an imaging apparatus including a zoom lens and an imaging device that converts an optical image formed by the zoom lens into an electric signal. The zoom lens includes a first lens group including a reflection member that deflects an optical path by 90 degrees and having positive refracting power, a second lens group having negative refracting power, a third lens group having positive refracting power, at least one lens group having negative refracting power and at least one lens group having positive refracting power disposed as a fourth lens group and the following lens groups, the first to third lens groups and the fourth and following lens groups arranged in this order from an object side toward an image side. The zoom lens further includes an aperture diaphragm disposed in the vicinity of the third lens group. When zooming is performed from a wide angle end state to a telescopic end state, the lens groups described above are moved as follows: the first lens group is fixed; the second lens group is moved toward the image side; and the fourth lens group is moved toward the object side. The zoom lens satisfies the following conditional equation (1):

1<(R1B+R21A)/(R1B−R21A)<20 (1)

where R1B represents the radius of curvature of the surface closest to an image plane in the first lens group, and R21A represents the radius of curvature of the surface closest to an object plane in the second lens group.

The imaging apparatus therefore includes at least one lens group having positive refracting power and at least one lens group having negative refracting power on the object and image sides of the aperture diaphragm, respectively.

When the zoom lens in the imaging apparatus satisfies the conditional equation (1), the shape of an air lens between the first and second lens groups has an appropriate shape.

The zoom lenses and the imaging apparatus according to the embodiments of the invention achieve reduction in size, increase in variable power ratio, and enhancement of performance while ensuring a wide angle of view.

### BRIEF DESCRIPTION OF THE DRAWINGS

FIG. 1 shows the lens configuration of a zoom lens according to a first example of the invention;

FIG. 2 shows aberration diagrams in a numerical example in which specific values are substituted into the first example and shows spherical aberration, field curvature, and distortion in a wide angle end state;

FIG. 3 shows aberration diagrams in the numerical example in which specific values are substituted into the first example and shows spherical aberration, field curvature, and distortion in an intermediate focal length state;

FIG. 4 shows aberration diagrams in the numerical example in which specific values are substituted into the first example and shows spherical aberration, field curvature, and distortion in a telescopic end state;

FIG. 5 shows the lens configuration of a zoom lens according to a second example of the invention;

FIG. 6 shows aberration diagrams in a numerical example in which specific values are substituted into the second example and shows spherical aberration, field curvature, and distortion in the wide angle end state;

FIG. 7 shows aberration diagrams in the numerical example in which specific values are substituted into the second example and shows spherical aberration, field curvature, and distortion in the intermediate focal length state;

FIG. 8 shows aberration diagrams in the numerical example in which specific values are substituted into the second example and shows spherical aberration, field curvature, and distortion in the telescopic end state;

FIG. 9 shows the lens configuration of a zoom lens according to a third example of the invention;

FIG. 10 shows aberration diagrams in a numerical example in which specific values are substituted into the third example and shows spherical aberration, field curvature, and distortion in the wide angle end state;

FIG. 11 shows aberration diagrams in the numerical example in which specific values are substituted into the third example and shows spherical aberration, field curvature, and distortion in the intermediate focal length state;

FIG. 12 shows aberration diagrams in the numerical example in which specific values are substituted into the third example and shows spherical aberration, field curvature, and distortion in the telescopic end state;

FIG. 13 shows the lens configuration of a zoom lens according to a fourth example of the invention;

FIG. 14 shows aberration diagrams in a numerical example in which specific values are substituted into the fourth example and shows spherical aberration, field curvature, and distortion in the wide angle end state;

FIG. 15 shows aberration diagrams in the numerical example in which specific values are substituted into the fourth example and shows spherical aberration, field curvature, and distortion in the intermediate focal length state;

FIG. 16 shows aberration diagrams in the numerical example in which specific values are substituted into the fourth example and shows spherical aberration, field curvature, and distortion in the telescopic end state;

FIG. 17 shows the lens configuration of a zoom lens according to a fifth example of the invention;

FIG. 18 shows aberration diagrams in a numerical example in which specific values are substituted into the fifth example and shows spherical aberration, field curvature, and distortion in the wide angle end state;

FIG. 19 shows aberration diagrams in the numerical example in which specific values are substituted into the fifth example and shows spherical aberration, field curvature, and distortion in the intermediate focal length state;

FIG. 20 shows aberration diagrams in the numerical example in which specific values are substituted into the fifth example and shows spherical aberration, field curvature, and distortion in the telescopic end state;

FIG. 21 shows the lens configuration of a zoom lens according to a sixth example of the invention;

FIG. 22 shows aberration diagrams in a numerical example in which specific values are substituted into the sixth example and shows spherical aberration, field curvature, and distortion in the wide angle end state;

FIG. 23 shows aberration diagrams in the numerical example in which specific values are substituted into the sixth example and shows spherical aberration, field curvature, and distortion in the intermediate focal length state;

FIG. 24 shows aberration diagrams in the numerical example in which specific values are substituted into the sixth example and shows spherical aberration, field curvature, and distortion in the telescopic end state; and

FIG. 25 shows a block diagram of an imaging apparatus according to an embodiment of the invention.

### DESCRIPTION OF THE PREFERRED EMBODIMENTS

The best mode for carrying out the invention and providing a zoom lens and an imaging apparatus according to embodiments thereof will be described below.

### [Configuration of Zoom Lens]

A zoom lens according to an embodiment of the invention includes a first lens group including a reflection member that deflects the optical path by 90 degrees and having positive refracting power, a second lens group having negative refracting power, a third lens group having positive refracting power, and at least one lens group having negative refracting power and at least one lens group having positive refracting power disposed as a fourth lens group and the following lens groups. The first to third lens groups and the fourth and following lens groups are arranged in this order from the object side toward the image side.

The zoom lens according to the embodiment of the invention further includes an aperture diaphragm disposed in the vicinity of the third lens group, and the lens groups described above are moved as follows when zooming is performed from a wide angle end state to a telescopic end state: The first lens group is fixed; the second lens group is moved toward the image side; and the fourth lens group is moved toward the object side.

The thus configured zoom lens according to the embodiment of the invention provides the following advantageous effects.

First, the aperture diaphragm is disposed in the vicinity of the third lens group, and the positive first lens group, the negative second lens group, the positive third lens group, and at least one lens group having negative refracting power and at least one lens group having positive refracting power as the fourth and following lens groups are disposed. At least one positive lens group and at least one negative lens group can therefore be disposed on the object and image sides of the aperture diaphragm, respectively. As a result, the arrangement of refracting power is nearly symmetric with respect to the aperture diaphragm, and negative distortion that tends to occur in the wide angle end state can be corrected in a satisfactory manner. A wider angle of view, for example, 75 degrees or greater, can therefore be achieved at the wide angle end.

Second, when zooming is performed from the wide angle end state to the telescopic end state, the second lens group is moved toward the image side and the fourth lens group is moved toward the object side, whereby the second and fourth lens groups can carry the burden of changing the magnification in a well balanced manner, and the amount of movement of each of the movable lens groups can be appropriately set. The size of the optical system can thus be reduced.

Third, the first lens group, which is fixed during zooming operation, provides waterproof and dustproof capabilities and allows a barrel configuration to be simplified.

Fourth, since the angle of view is large in the wide angle end state, off-axis light fluxes passing through the first and second lens groups are far away from the optical axis. The off-axis light fluxes passing through the first lens group can be made not too divergent by disposing the first and second lens groups close to each other.

Fifth, when the lens position setting is changed as the wide angle end state is changed toward the telescopic end state, the angle of view becomes smaller, and the off-axis light fluxes passing through the first and second lens groups shift toward the optical axis since the distance between the second lens group and the aperture diaphragm decreases. The change in height of the light fluxes passing through the first and second lens groups can be used to reduce the amount of change in off-axis aberration in a satisfactory manner that occurs when the lens position setting is changed.

The zoom lens according to the embodiment of the invention satisfies the following conditional equation (1):

1<(R1B+R21A)/(R1B−R21A)<20 (1)

where R1B represents the radius of curvature of the surface closest to an image plane in the first lens group, and R21A represents the radius of curvature of the surface closest to an object plane in the second lens group.

The conditional equation (1) defines a preferable shape of an air lens between the first and second lens groups so that predetermined optical performance is provided at the wide angle end.

When the value of the conditional equation (1) is smaller than the lower limit thereof, the radius of curvature of the surface closest to the image plane in the first lens group increases. In this case, distortion at the wide angle end increases in the negative direction, and it is difficult to correct astigmatism and other off-axis aberrations at the telescopic end in a satisfactory manner.

Conversely, when the value of the conditional equation (1) is greater than the upper limit thereof, the difference between the radius of curvature of the surface closest to the image plane in the first lens group and the radius of curvature of the surface closest to the object plane in the second lens group becomes too small, and it is difficult to correct astigmatism and other off-axis aberrations at the wide angle end and spherical and comatic aberrations at the telescopic end in a satisfactory manner.

Off-axis aberrations at the wide angle end and spherical and comatic aberrations at the telescopic end can be corrected in a satisfactory manner when the zoom lens satisfies the conditional equation (1).

The lower and upper limits of the conditional equation (1) are more preferably 2 and 10, respectively.

The thus configured zoom lens according to the embodiment of the invention can provide an angle of view ranging from approximately 75 to 85 degrees in the wide angle end state, a variable power ratio ranging from approximately 5 to 8, and an f-number ranging from approximately 3.4 to 3.7 in the wide angle end state, whereby a compact size, a high variable power ratio, and high performance are achieved while a wide angle of view is ensured.

In the zoom lens according to an embodiment of the invention, the first lens group is desirably formed of a negative meniscus lens with a convex surface facing the object side, the reflection member described above, and a positive lens arranged in this order from the object side toward the image side.

When the reflection member, which deflects the optical path, is disposed in the first lens group, the entrance pupil tends to be disposed in a position far away from the surface of the first lens group on which light is incident, disadvantageously resulting in increase in the size of the first lens group. The entrance pupil position can be closer to the surface of the first lens group on which light is incident by configuring the first lens group in such a way that a negative meniscus lens, a reflection member, and a positive lens are arranged in this order from the object side toward the image side as described above, whereby the angle of the principal ray passing through the reflection member with respect to the optical axis decreases and the size of the first lens group is reduced accordingly.

In the zoom lens according to an embodiment of the invention, the second lens group is desirably formed of a first portion group and a second portion group arranged in this order from the object side toward the image side. It is also desirable that the first portion group is formed of a negative biconcave lens and the second portion group is formed of one or two lenses including a positive lens.

To increase the variable power ratio in the present zoom lens, it is necessary to increase the negative refracting power of the second lens group. To this end, the first portion group is formed of a negative biconcave lens as described above so that both surfaces of the negative lens share the burden of producing the negative refracting power, whereby aberrations can be corrected in a satisfactory manner even when the second lens group has high refracting power.

Further, since the first portion group is set apart from the aperture diaphragm in the wide angle end state, the height of each light ray passing through the first portion group greatly changes as the angle of view changes, whereby distortion, astigmatism, and other off-axis aberrations can be corrected in a satisfactory manner across the entire zooming area.

Moreover, the second portion group, which is disposed in the vicinity of the aperture diaphragm, primarily functions to correct spherical aberrations. The positive lens disposed in the second portion group can cancel several types of aberration induced in the negative lens in the first portion group and suppress aberrations induced in the second lens group.

To reduce the burden of correcting aberrations on the negative lens in the first portion group, the second portion group is desirably formed of a single positive lens and a single negative lens. When the second portion group is formed of one or two lenses, the thickness of the second lens group in the optical axis direction can be reduced, and the second lens group can be moved by a sufficient distance to increase the variable power ratio.

The zoom lens according to an embodiment of the invention desirably satisfies the following conditional equation (2):

−10<(R21B+R22A)/(R21B−R22A)<0 (2)

where R21B represents the radius of curvature of the surface closest to the image plane in the first portion group in the second lens group, and R22A represents the radius of curvature of the surface closest to the object plane in the second portion group in the second lens group.

The conditional equation (2) defines a preferable shape of an air lens between the first and second portion groups in the second lens group so that predetermined optical performance is provided.

When the value of the conditional equation (2) is smaller than the lower limit thereof, the object-side surface of the second portion group in the second lens group has a concave shape greatly protruding toward the image side, and it is therefore difficult to correct astigmatism and other off-axis aberrations induced in the second lens group across the entire zooming area. Aberrations induced by zooming operation therefore greatly change, disadvantageously resulting in increase in the amount of off-axis aberrations at both the wide angle and telescopic ends.

Conversely, when the value of the conditional equation (2) is greater than the upper limit thereof, the object-side surface of the second portion group in the second lens group has a convex shape greatly protruding toward the object side, and it is therefore difficult to correct astigmatism and comma induced at the telescopic end in a satisfactory manner.

The amount of change in the aberrations induced by zooming operation can be reduced and astigmatism, comma, and other off-axis aberrations can be corrected in a satisfactory manner when the zoom lens satisfies the conditional equation (2), whereby the performance of the zoom lens can be enhanced.

The lower and upper limits of the conditional equation (2) are more preferably −4 and −0.5, respectively.

The zoom lens according to an embodiment of the invention desirably satisfies the following conditional equation (3):

0<D12t/ft<0.4 (3)

where D12t represents the distance from the apex of the surface closest to the image plane in the first lens group to the apex of the surface closest to the object plane in the second lens group at the telescopic end, and ft represents the focal length of the whole lens system at the telescopic end.

The conditional equation (3) defines the ratio of the distance from the apex of the surface closest to the image plane in the first lens group to the apex of the surface closest to the object plane in the second lens group at the telescopic end to the focal length of the whole lens system at the telescopic end.

When the value of the conditional equation (3) is smaller than the lower limit thereof, the lateral magnification of the second lens group does not greatly change, and the burden of changing the magnification on the second lens group decreases. The burden of changing the magnification on the other lens groups, however, increases too much, and it is therefore difficult to provide predetermined optical performance.

Conversely, when the value of the conditional equation (3) is greater than the upper limit thereof, the lateral magnification of the second lens group greatly changes. As a result, when the second lens group has the simplified configuration described above, the amount of off-axis aberrations induced by zooming operation greatly change.

The lateral magnification of the second lens group changes appropriately and the off-axis aberrations are corrected in a satisfactory manner when the zoom lens satisfies the conditional equation (3), whereby the performance of the zoom lens can be enhanced.

The lower and upper limits of the conditional equation (3) are more preferably 0.2 and 0.34, respectively.

In the zoom lens according to an embodiment of the invention, the lens group disposed in a position closest to the image plane desirably has positive refracting power.

Configuring the lens group disposed in a position closest to the image plane to have positive refracting power allows the exit pupil position to shift away from the image plane so that the zoom lens becomes a telecentric system, whereby decrease in the amount of peripheral light can be reduced and other advantageous effects are provided.

In the zoom lens according to an embodiment of the invention, a biconvex lens is desirably disposed in the third lens group in a position closest to the object plane.

To increase the variable power ratio in the present zoom lens, it is necessary to increase the positive refracting power of the third lens group. To this end, a biconvex lens is disposed in the third lens group in a position closest to the object plane so that both surfaces of the lens share the burden of producing the positive refracting power, whereby spherical aberrations can be corrected in a satisfactory manner across the entire zooming area even when the third lens group has high refracting power.

In the zoom lens according to an embodiment of the invention, the fourth lens group is desirably formed of a single lens or a doublet.

Since the fourth lens group is a movable group, a load of moving the fourth lens group on a drive mechanism can be minimized by forming the fourth lens group with a single lens. Alternatively, the amount of chromatic aberration can be minimized by configuring the fourth lens group with a doublet.

Using the fourth lens group, which is small in size as described above, to perform focusing is also desirable to perform autofocus at higher speed.

In the zoom lens according to an embodiment of the invention, it is desirable to move any one of the lens groups downstream of the third lens group but other than the fourth lens group in the optical axis direction during zooming operation.

When another movable group other than the second and fourth lens groups is configured to move in the optical axis direction so that the number of movable groups is three, the three groups can carry the burden of changing the magnification in a well balanced manner and the amount of movement of each of the groups can be appropriately set, whereby the size of the optical system can be reduced.

The zoom lens according to an embodiment of the invention desirably satisfies the following conditional equation (4):

0.1<|f21/(fw×ft)^{1/2}|<1.5 (4)

where f21 represents the focal length of the first portion group in the second lens group, fw represents the focal length of the whole lens system at the wide angle end, and ft represents the focal length of the whole lens system at the telescopic end.

The conditional equation (4) defines the ratio of the focal length of the first portion group in the second lens group to the focal length related to the whole lens system.

When the value of the conditional equation (4) is smaller than the lower limit thereof, the refracting power of the first portion group in the second lens group becomes too high. In this case, it is difficult to correct astigmatism, comma, and other off-axis aberrations at the wide angle end, and the performance of the zoom lens is more sensitive to an error produced when the first and second portion groups are assembled, resulting in decrease in the performance in a manufacturing step.

Conversely, when the value of the conditional equation (4) is greater than the upper limit thereof, the refracting power of the first portion group in the second lens group becomes too small. In this case, off-axis light fluxes passing through the first portion group in the second lens group and the first lens group disadvantageously shift away from the optical axis at the wide angle end, resulting in increase in lens diameter and increase in the amount of off-axis aberration.

When the zoom lens satisfies the conditional equation (4), the following advantageous effects are provided: The off-axis aberrations can be corrected in a satisfactory manner; the sensitivity to an error in the assembly step can be reduced; and the size of the zoom lens can be reduced.

The lower and upper limits of the conditional equation (4) are more preferably 0.2 and 0.7, respectively.

The zoom lens according to an embodiment of the invention desirably satisfies the following conditional equation (5):

0.1<|f12/(fw×ft)^{1/2}|<1.5 (5)

where f12 represents the focal length of the positive lens disposed on the image side of the reflection member in the first lens group, fw represents the focal length of the whole lens system at the wide angle end, and ft represents the focal length of the whole lens system at the telescopic end.

The conditional equation (5) defines the ratio of the focal length of the positive lens disposed on the image side of the reflection member in the first lens group to the focal length related to the whole lens system.

When the value of the conditional equation (5) is smaller than the lower limit thereof, the refracting power of the positive lens becomes too high. At the same time, astigmatism increases at the wide angle end, and it is difficult to correct the astigmatism and comma at the telescopic end in a satisfactory manner.

Conversely, when the value of the conditional equation (5) is greater than the upper limit thereof, light rays converge insufficiently on the image side of the reflection member. In this case, off-axis light fluxes passing through the first lens group disadvantageously shift away from the optical axis at the wide angle end, disadvantageously resulting in increase in lens diameter.

The size of the zoom lens can be reduced and astigmatism and other off-axis aberrations can be corrected in a satisfactory manner when the zoom lens satisfies the conditional equation (5).

The lower and upper limits of the conditional equation (5) are more preferably 0.7 and 0.96, respectively.

The zoom lens according to an embodiment of the invention desirably satisfies the following conditional equation (6):

0.5<|f11/(fw×ft)^{1/2}1<2.0 (6)

where f11 represents the focal length of the negative meniscus lens disposed on the object side of the reflection member in the first lens group, fw represents the focal length of the whole lens system at the wide angle end, and ft represents the focal length of the whole lens system at the telescopic end.

The equation (6) defines the ratio of the focal length of the negative meniscus lens disposed on the object side of the reflection member in the first lens group to the focal length related to the whole lens system.

When the value of the conditional equation (6) is smaller than the lower limit thereof, the refracting power of the negative meniscus lens becomes too high. In this case, it is difficult to correct distortion at the wide angle end, and it is necessary to increase the positive refracting power of the lens disposed on the image side of the reflection member in order for the first lens group to have positive refracting power. As a result, the performance of the zoom lens becomes more sensitive to an error in an assembling step, resulting in increase in difficulty in a manufacturing step.

Conversely, when the value of the conditional equation (6) is greater than the upper limit thereof, the entrance pupil position shifts away from the surface of the first lens group on which light is incident. In this case, increasing the angle of view, for example, to approximately 80 degrees typically requires increasing the size of the first lens group.

The distortion at the wide angle end can be corrected in a satisfactory manner, and the zoom lens can be readily manufactured and reduced in size when the zoom lens satisfies the conditional equation (6).

The lower and upper limits of the conditional equation (6) are more preferably 0.95 and 1.6, respectively.

In the zoom lens according to an embodiment of the invention, the lens groups are desirably configured as follows in order to ensure satisfactory optical performance and achieve a wide angle of view, a high variable power ratio, and a compact size.

The first lens group is desirably formed of a negative meniscus lens with a convex surface facing the object side, a reflection member that deflects the optical path by 90 degrees, and a biconvex lens arranged in this order from the object side toward the image side.

When a rectangular prism is used as the reflection member, a drive mechanism needs to carry a large burden of moving the reflection member, which is heavy, during zooming operation. The first lens group is therefore desirably fixed with respect to the image plane during zooming operation.

The reflection member in the first lens group is desirably, for example, a rectangular prism having a high refracting index ranging from approximately 1.8 to 2.0. A higher refractive index of the reflection member readily allows further size reduction and achieves a higher variable power ratio.

In the first lens group, in particular, since a large-diameter, on-axis light flux is incident thereon at the telescopic end, spherical aberrations tend to occur. Further, off-axis light fluxes incident on the first lens group in positions apart from the optical axis tend to induce comma, astigmatism, and other off-axis aberrations. It is therefore desirable that at least one of the surfaces that form the first lens group is an aspheric surface from a viewpoint of aberration correction.

The second lens group is desirably formed of first and second portion groups. Forming the second lens group with the first and second portion groups allows several types of aberration induced in the second lens group to be corrected in a satisfactory manner, whereby higher optical performance is achieved.

Specifically, it is desirable that the first portion group is formed of a negative biconcave lens and the second portion group is formed of one or two lenses including a positive lens. Since the first portion group is far away from the aperture diaphragm, the height at which each light ray passes through the first portion group greatly changes as the angle of view changes, whereby distortion, astigmatism, and other off-axis aberrations are corrected in a satisfactory manner across the entire zooming area. Further, forming at least one of the surfaces of the negative lens in the first portion group with an aspheric surface allows the off-axis aberrations to be corrected in a more satisfactory manner.

The second portion group is desirably formed of at least a single positive lens. Being disposed in the vicinity of the aperture diaphragm, the second portion group primarily functions to correct spherical aberrations.

Further, the second portion group is desirably formed of a single positive lens and a single negative lens in order to reduce the burden of correcting aberrations on the negative lens in the first portion group. It is also possible to bond the positive and negative lenses into a doublet so that the structure of the second portion group is simplified.

The third lens group desirably has a positive biconvex lens in a position closest to the object plane.

Disposing a positive biconvex lens in the third lens group in a position closest to the object plane allows spherical aberrations to be corrected in a satisfactory manner even when the third lens group has high refracting power. Further, forming at least one surface of the positive lens with an aspheric surface allows spherical aberrations to be corrected in a more satisfactory manner.

The fourth lens group is desirably formed of a single lens or a doublet and used to perform focusing.

Forming the fourth lens group with a single lens or a doublet minimizes the burden of moving the fourth lens group on a drive mechanism. Further, forming at least one of the surfaces that form the fourth lens group with an aspheric surface allows the amount of change in several types of aberration induced by focusing operation to be corrected in a satisfactory manner.

The lens group disposed in a position closest to the image plane desirably has positive refracting power.

Disposing a lens group having positive refracting power as the lens group in a position closest to the image plane allows the zoom lens to be a telecentric system. Further, off-axis light fluxes passing through the lens group disposed in a position closest to the image plane are far away from the optical axis. It is therefore possible to correct distortion, astigmatism, and other off-axis aberrations in a more satisfactory manner by forming at least one of the surfaces that form the lens group disposed in a position closest to the image plane with an aspheric surface.

In the zoom lens according to the embodiment of the invention, the position of an image can be shifted by shifting one of the first to fifth lens groups or part of the lenses in one of the lens groups in a direction substantially perpendicular to the optical axis.

In particular, shifting a lens group fixed during zooming operation or part of the lenses in that lens group in a direction substantially perpendicular to the optical axis allows the amount of change in aberration to be reduced and a barrel structure to be simplified.

Further, combining the zoom lens capable of shifting the position of an image with a detection system that detects image movement, drive systems that shift the lens groups, and a control system that provides the amount of shift to the drive system based on an output from the detection system allows the zoom lens to function as a anti-vibration optical system that corrects hand shaking and image blur.

It is also possible to dispose a low-pass filter on the image side of the lens system that prevents moire fringes from being produced and an infrared absorbing filter in accordance with the spectral sensitivity characteristic of a light receiving device.

In the zoom lens according to the embodiment of the invention, since the negative lens having high refracting power is disposed in the light incident plane, and light rays pass through the negative biconcave lens, which forms the first portion group in the second lens group, in positions far away from the optical axis at the wide angle end, barrel-shaped distortion tends to occur at the wide angle end. To address the problem, it is desirable to allow a user to view an image after image deformation due to distortion induced in the optical system is corrected by using a function of processing captured image data to change the image deformation. Further, the height of each incident light ray at the wide angle end becomes lower by intentionally inducing barrel-shaped distortion even when the angle of view is large. As a result, the diameter of the first lens group and the size of the reflection member in the first lens group can be reduced, whereby the size of the zoom lens can be further reduced.

### [Numerical Examples for Zoom Lens]

Specific examples of the zoom lens according to the embodiment of the invention and numerical examples in which specific values are substituted into the specific examples will be described below with reference to the drawings and tables.

The meanings and other information of the symbols shown in the following tables and descriptions are as follows.

Reference character “Di” denotes an on-axis variable distance between an i-th surface and an (i+1)-th surface. Reference character “f” denotes a focal length. Reference character “Fno” denotes an f-number. Reference character “ω” denotes half an angle of view. In the field of the surface number (r), “ASP” indicates that the surface is an aspheric surface, and in the field of the radius of curvature, “ω” indicates that the surface is a flat surface.

The refractive indices and Abbe numbers are based on the d line (λ=587.6 nm).

Some lenses used in each numerical example have an aspheric lens surface. An aspheric surface is defined by the following equation:

$$x = \frac{{cy}^{2}}{[ 1 + {\{ 1 - ( 1 + κ ) {c}^{2} {y}^{2} \}}^{1 / 2} ]} + {Ay}^{4} + {By}^{6} + {Cy}^{8} + {Dy}^{10}$$

where reference character “x” denotes the distance from the apex of the lens surface in the optical axis direction (the amount of sag), reference character “y” denotes the height in the direction perpendicular to the optical axis direction (image height), reference character “c” denotes paraxial curvature at the apex of the lens (reciprocal of radius of curvature), reference character “κ” denotes a conic constant, and reference characters “A”, “B”, “C”, and “D” denote fourth, sixth, eighth, and tenth aspheric coefficients, respectively.

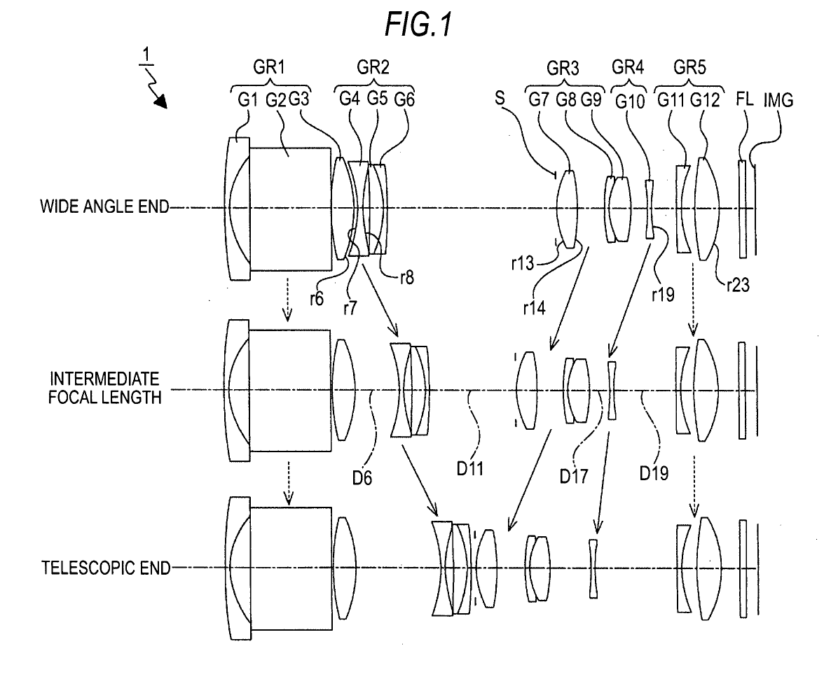

FIGS. 1, 5, 9, 13, 17, and 21 show the lens configurations of zoom lenses 1 to 6 in First to Sixth Examples of the invention.

In each of the figures, the upper portion shows lens positions in the wide angle end state, the middle portion shows lens positions in an intermediate focal length state, and the lower portion shows lens positions in the telescopic end state. Movable lenses change their positions indicated by arrows as the focal length at the wide angle end changes to that at the telescopic end. A solid arrow indicates that the lens in question is moved during zooming operation, and a broken arrow indicates that the lens in question is stationary during zooming operation.

### First Example

FIG. 1 shows the lens configuration of a zoom lens 1 in First Example of the invention.

The zoom lens 1 includes a first lens group GR1 having positive refracting power, a second lens group GR2 having negative refracting power, a third lens group GR3 having positive refracting power, a fourth lens group GR4 having negative refracting power, and a fifth lens group GR5 having positive refracting power arranged in this order from the object side toward the image side.

The zoom lens 1 has a variable power ratio of 5.5.

The first lens group GR1 is formed of a negative meniscus lens G1 with a convex surface facing the object side, a rectangular prism G2 used as a reflection member for deflecting the optical path by 90 degrees, and a positive biconvex lens G3 arranged in this order from the object side toward the image side.

The second lens group GR2 is formed of a negative biconcave lens G4 and a doublet obtained by bonding a positive meniscus lens G5 with a convex surface facing the image side to a negative meniscus lens G6 with a concave surface facing the object side arranged in this order from the object side toward the image side.

The third lens group GR3 is formed of a positive biconvex lens G7, a negative meniscus lens G8 with a convex surface facing the object side, and a positive biconvex lens G9 arranged in this order from the object side toward the image side.

The fourth lens group GR4 is formed of a negative biconcave lens G10.

The fifth lens group GR5 is formed of a negative lens G11 with a concave surface facing the image side and a positive biconvex lens G12 arranged in this order from the object side toward the image side.

A filter FL is disposed between the fifth lens group GR5 and an image plane IMG.

An aperture diaphragm S is disposed in the vicinity and on the objective side of the third lens group GR3 and moves integrally with the third lens group GR3.

In zooming operation, the second lens group GR2, the third lens group GR3, and the fourth lens group GR4 are movable lens groups, and the first lens group GR1 and the fifth lens group GR5 are fixed lens groups.

Table 1 shows lens data in Numerical Example 1 in which specific values are substituted into the zoom lens 1 in First Example.

TABLE 1

| Surface | | Radius of | Intersurface | Refractive | |
|---|---|---|---|---|---|
| number (r) | | curvature | distance | index | Abbe number |
| 1 | | 37.7960 | 0.500 | 1.92290 | 20.88 |
| 2 | | 7.7467 | 1.800 | | |
| 3 | | ∞ | 8.000 | 1.90370 | 31.31 |
| 4 | | ∞ | 0.100 | | |
| 5 | | 21.5114 | 1.988 | 1.76800 | 49.24 |
| 6 | (ASP) | −12.1733 | (D6) | | |
| 7 | (ASP) | −9.0838 | 0.450 | 1.88690 | 37.15 |
| 8 | (ASP) | 15.9842 | 0.557 | | |
| 9 | | −126.8479 | 1.542 | 1.94590 | 17.98 |
| 10 | | −8.6248 | 0.400 | 1.88610 | 37.57 |
| 11 | | −39.5742 | (D11) | | |
| 12 | (aperture | ∞ | 0.100 | | |
| | diaphragm) | | | | |
| 13 | (ASP) | 6.7467 | 1.854 | 1.62260 | 58.53 |
| 14 | (ASP) | −20.1059 | 2.706 | | |
| 15 | | 14.8694 | 0.492 | 1.98770 | 25.79 |
| 16 | | 5.1616 | 1.994 | 1.49730 | 81.50 |
| 17 | | −12.3332 | (D17) | | |
| 18 | | −21.9142 | 0.400 | 1.88300 | 40.80 |
| 19 | (ASP) | 12.6031 | (D19) | | |
| 20 | | 171.5413 | 0.400 | 1.80520 | 25.46 |
| 21 | | 10.2930 | 1.142 | | |
| 22 | | 23.1052 | 2.509 | 1.73270 | 47.01 |
| 23 | (ASP) | −8.6823 | 2.000 | | |
| 24 | | ∞ | 0.500 | 1.55670 | 58.56 |
| 25 | | ∞ | 1.000 | | |

In the zoom lens 1, the following surfaces are aspheric surfaces: the image-side surface (sixth surface) of the positive lens G3 in the first lens group GR1, both surfaces (seventh and eighth surfaces) of the negative lens G4 in the second lens group GR2, both surfaces (thirteenth and fourteenth surfaces) of the positive lens G7 in the third lens group GR3, the image-side surface (nineteenth surface) of the negative lens G10 in the fourth lens group GR4, and the image-side surface (twenty third surface) of the positive lens G12 in the fifth lens group GR5. Table 2 shows the fourth, sixth, eighth, and tenth aspheric coefficients A, B, C, D and the conic constant κ of the aspheric surfaces in Numerical Example 1.

In Table 2 and each table described later showing aspheric coefficients, “E-i” represents exponential notation using a base of 10, that is, “10⁻ⁱ.” For example, “0.12345E-05” represents “0.12345×10⁻⁵.”

TABLE 2

| | κ | A | B | C | D |
|---|---|---|---|---|---|
| 6th surface | 0.00000E+00 | 7.06123E−05 | 1.42957E−08 | 2.35839E−09 | 0.00000E+00 |
| 7th surface | 0.00000E+00 | 4.42386E−04 | 5.93997E−07 | −8.90320E−09 | 0.00000E+00 |
| 8th surface | 0.00000E+00 | 1.00034E−04 | 1.47341E−06 | 5.36395E−08 | 0.00000E+00 |
| 13th surface | 0.00000E+00 | −4.02509E−04 | −2.93683E−06 | −6.69069E−08 | 0.00000E+00 |
| 14th surface | 0.00000E+00 | 2.44726E−04 | −2.61378E−07 | 0.00000E+00 | 0.00000E+00 |
| 19th surface | 0.00000E+00 | 1.25962E−03 | 3.86491E−05 | 2.72014E−06 | 0.00000E+00 |
| 23rd surface | 0.00000E+00 | 1.30621E−04 | −7.47399E−06 | 1.49292E−08 | 0.00000E+00 |

Table 3 shows the f-numbers Fno and half the angles of view ω in the wide angle end state (f=4.60), the intermediate focal length state (f=10.42), and the telescopic end state (f=25.52) in Numerical Example 1.

TABLE 3

| | Wide angle end | Intermediate focal length | Telescopic end |
|---|---|---|---|
| f | 4.60 | 10.42 | 25.52 |
| Fno | 3.44 | 4.59 | 5.92 |
| ω | 40.01 | 20.33 | 8.60 |

In the zoom lens 1, when the magnification is changed between the wide angle end state and the telescopic end state, the following intersurface distances change: the intersurface distance D6 between the first lens group GR1 and the second lens group GR2, the intersurface distance D11 between the second lens group GR2 and the aperture diaphragm S, the intersurface distance D17 between the third lens group GR3 and the fourth lens group GR4, and the intersurface distance D19 between the fourth lens group GR4 and the fifth lens group GR5. Table 4 shows the variable intersurface distances in the wide angle end state (f=4.60), the intermediate focal length state (f=10.42), and the telescopic end state (f=25.52) in Numerical Example 1.

TABLE 4

| | Wide angle end | Intermediate focal length | Telescopic end |
|---|---|---|---|
| F | 4.60 | 10.42 | 25.52 |
| D6 | 0.400 | 4.517 | 8.396 |
| D11 | 16.397 | 8.311 | 0.400 |
| D17 | 1.585 | 1.968 | 3.923 |
| D19 | 2.544 | 6.126 | 8.206 |

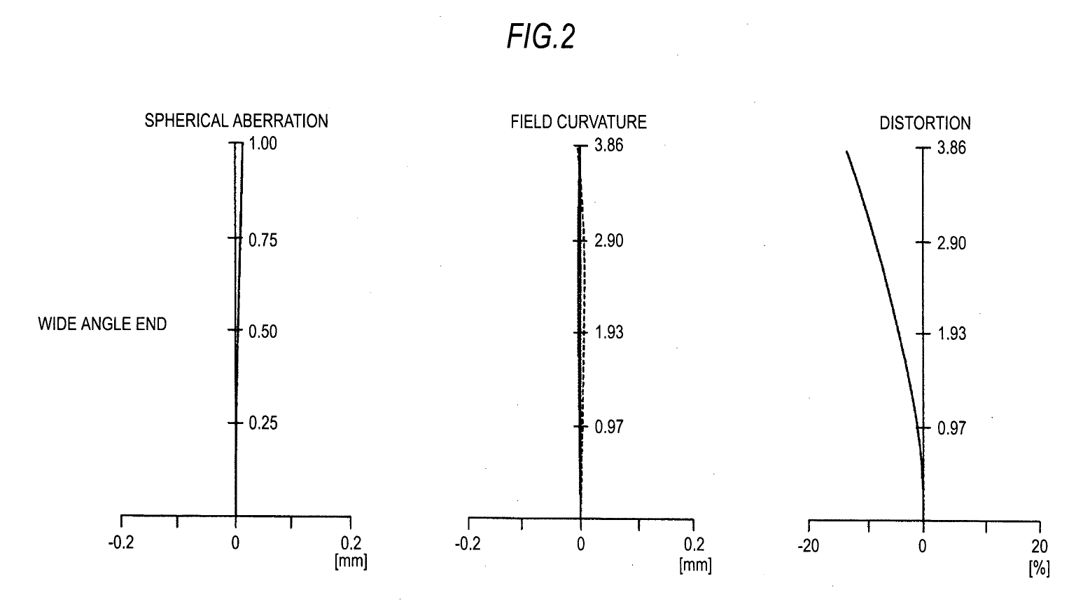

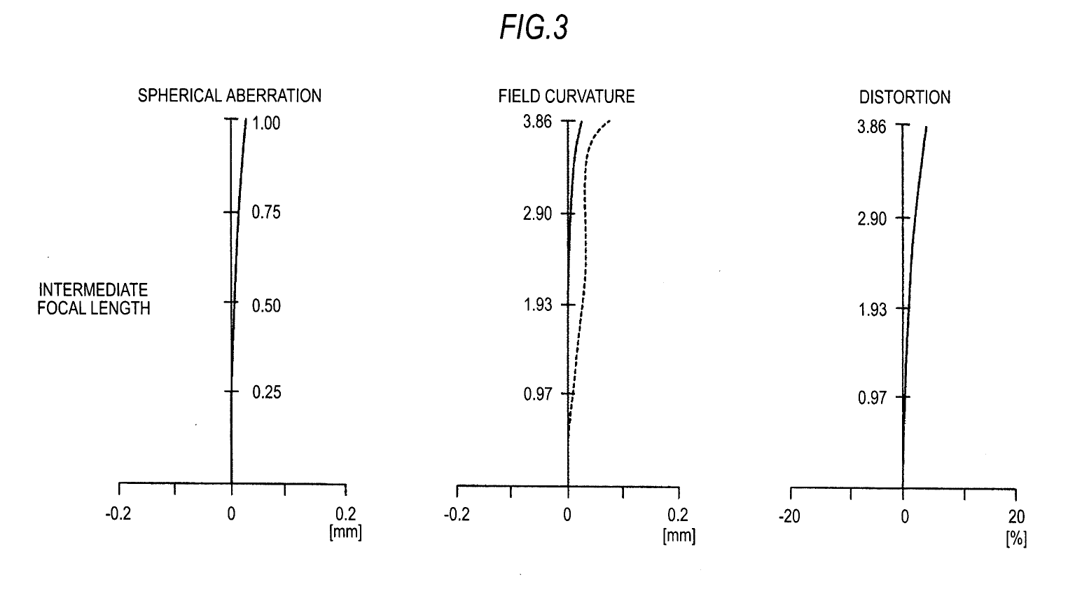

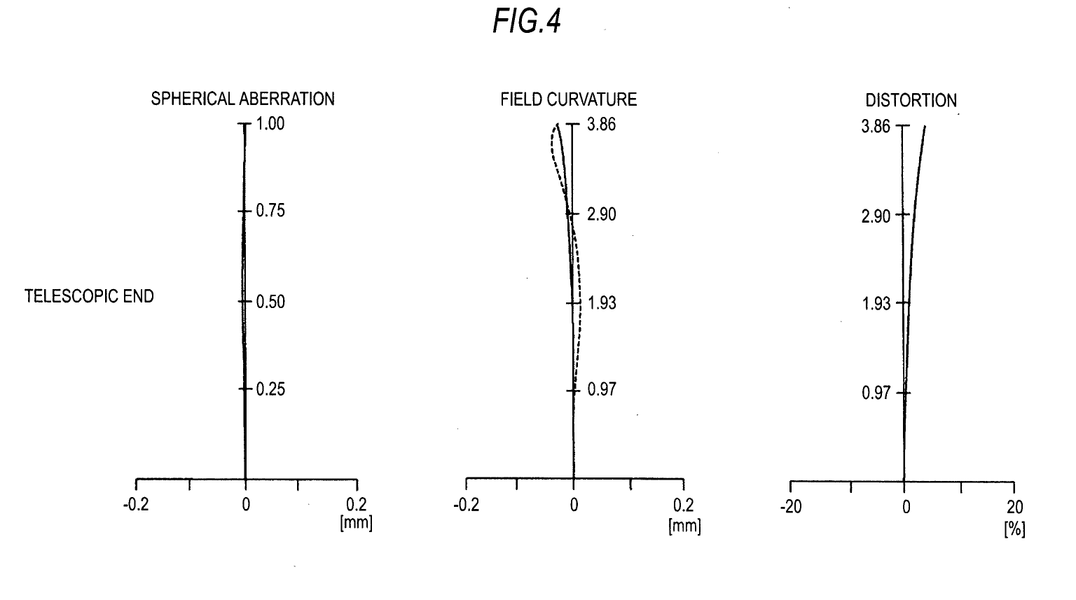

FIGS. 2 to 4 show aberration diagrams in a state in which an infinite point is brought into focus in Numerical Example 1. FIG. 2 shows aberration diagrams in the wide angle end state (f=4.60). FIG. 3 shows aberration diagrams in the intermediate focal length state (f=10.42). FIG. 4 shows aberration diagrams in the telescopic end state (f=25.52).

In the field curvature diagrams in FIGS. 2 to 4, solid lines represent values in the sagittal image plane, and broken lines represent values in the meridional image plane.

The aberration diagrams clearly show that the aberrations have been corrected in a satisfactory manner and excellent imaging performance has been achieved in Numerical Example 1.

### Second Example

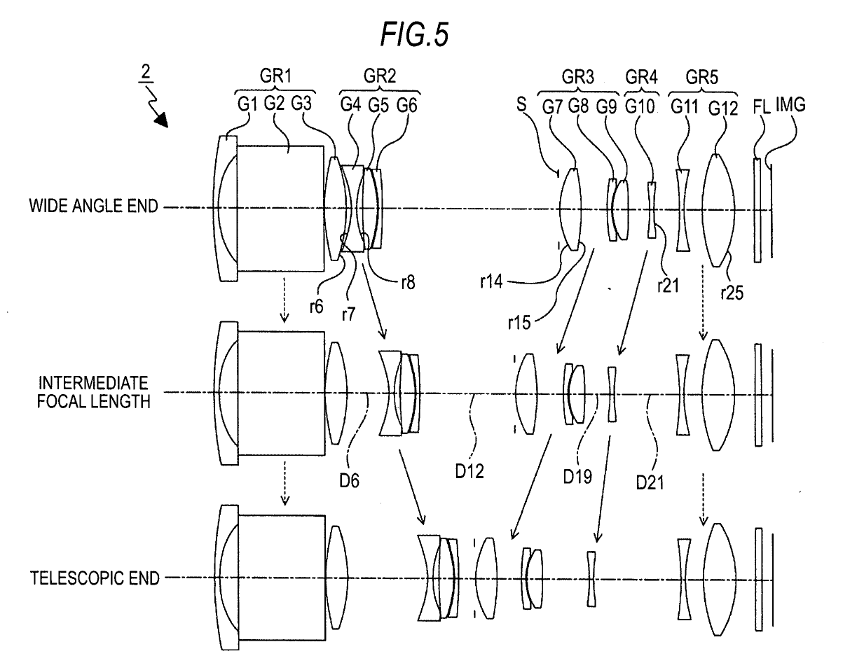

FIG. 5 shows the lens configuration of a zoom lens 2 in Second Example of the invention.

The zoom lens 2 includes a first lens group GR1 having positive refracting power, a second lens group GR2 having negative refracting power, a third lens group GR3 having positive refracting power, a fourth lens group GR4 having negative refracting power, and a fifth lens group GR5 having positive refracting power arranged in this order from the object side toward the image side.

The zoom lens 2 has a variable power ratio of 6.4.

The first lens group GR1 is formed of a negative meniscus lens G1 with a convex surface facing the object side, a rectangular prism G2 used as a reflection member for deflecting the optical path by 90 degrees, and a positive biconvex lens G3 arranged in this order from the object side toward the image side.

The second lens group GR2 is formed of a negative biconcave lens G4, a positive biconvex lens G5, and a negative meniscus lens G6 with a concave surface facing the object side.

The third lens group GR3 is formed of a positive biconvex lens G7, a negative meniscus lens G8 with a convex surface facing the object side, and a positive biconvex lens G9 arranged in this order from the object side toward the image side.

The fourth lens group GR4 is formed of a negative biconcave lens G10.

The fifth lens group GR5 is formed of a negative biconcave lens G11 and a positive biconvex lens G12 arranged in this order from the object side toward the image side.

A filter FL is disposed between the fifth lens group GR5 and an image plane IMG.

An aperture diaphragm S is disposed in the vicinity and on the objective side of the third lens group GR3 and moves integrally with the third lens group GR3.

In zooming operation, the second lens group GR2, the third lens group GR3, and the fourth lens group GR4 are movable lens groups, and the first lens group GR1 and the fifth lens group GR5 are fixed lens groups.

Table 5 shows lens data in Numerical Example 2 in which specific values are substituted into the zoom lens 2 in Second Example.

TABLE 5

| Surface | | Radius of | Intersurface | Refractive | |
|---|---|---|---|---|---|
| number (r) | | curvature | distance | index | Abbe number |
| 1 | | 31.2743 | 0.500 | 1.92290 | 20.88 |
| 2 | | 7.7644 | 1.800 | | |
| 3 | | ∞ | 8.000 | 1.90370 | 31.31 |
| 4 | | ∞ | 0.100 | | |
| 5 | | 16.0127 | 2.184 | 1.72840 | 54.08 |
| 6 | (ASP) | −11.2055 | (D6) | | |
| 7 | (ASP) | −7.4234 | 0.450 | 1.85130 | 40.10 |
| 8 | (ASP) | 8.8331 | 0.568 | | |
| 9 | | 65.9588 | 1.300 | 1.94590 | 17.98 |
| 10 | | −9.9747 | 0.100 | | |
| 11 | | −10.0005 | 0.400 | 1.88300 | 40.80 |
| 12 | | −35.3905 | (D12) | | |
| 13 | (aperture | ∞ | 0.100 | | |
| | diaphragm) | | | | |
| 14 | (ASP) | 5.8984 | 2.102 | 1.62260 | 58.16 |
| 15 | (ASP) | −17.4548 | 2.303 | | |
| 16 | | 21.5824 | 0.400 | 2.00070 | 25.46 |
| 17 | | 5.1745 | 0.100 | | |
| 18 | | 5.0810 | 1.538 | 1.49700 | 81.61 |
| 19 | | −27.4854 | (D19) | | |
| 20 | | −17.9877 | 0.400 | 1.85130 | 40.10 |
| 21 | (ASP) | 31.6695 | (D21) | | |
| 22 | | −21.4913 | 0.400 | 1.90370 | 31.31 |
| 23 | | 12.5809 | 1.675 | | |
| 24 | | 14.9689 | 2.959 | 1.74330 | 49.33 |
| 25 | (ASP) | −8.3730 | 2.000 | | |
| 26 | | ∞ | 0.500 | 1.55670 | 58.56 |
| 27 | | ∞ | 1.000 | | |

In the zoom lens 2, the following surfaces are aspheric surfaces: the image-side surface (sixth surface) of the positive lens G3 in the first lens group GR1, both surfaces (seventh and eighth surfaces) of the negative lens G4 in the second lens group GR2, both surfaces (fourteenth and fifteenth surfaces) of the positive lens G7 in the third lens group GR3, the image-side surface (twenty first surface) of the negative lens G10 in the fourth lens group GR4, and the image-side surface (twenty fifth surface) of the positive lens G12 in the fifth lens group GR5. Table 6 shows the fourth, sixth, eighth, and tenth aspheric coefficients A, B, C, D and the conic constant κ of the aspheric surfaces in Numerical Example 2.

TABLE 6

| | κ | A | B | C | D |
|---|---|---|---|---|---|
| 6th surface | 0.00000E+00 | 1.79122E−04 | −3.14352E−07 | 1.40932E−08 | 0.00000E+00 |
| 7th surface | 0.00000E+00 | 8.10506E−04 | 3.08281E−06 | 2.73206E−08 | 0.00000E+00 |
| 8th surface | 0.00000E+00 | −2.63976E−04 | 1.36888E−05 | −1.81139E−07 | 0.00000E+00 |
| 14th surface | 0.00000E+00 | −5.33311E−04 | −5.39062E−06 | −2.21278E−07 | 0.00000E+00 |
| 15th surface | 0.00000E+00 | 3.18522E−04 | −7.30264E−08 | 0.00000E+00 | 0.00000E+00 |
| 21st surface | 0.00000E+00 | 1.52773E−03 | 9.96328E−05 | 3.06049E−06 | 0.00000E+00 |
| 25th surface | 0.00000E+00 | 4.41313E−04 | −1.45592E−05 | 3.25270E−07 | 0.00000E+00 |

Table 7 shows the f-numbers Fno and half the angles of view ω in the wide angle end state (f=4.60), the intermediate focal length state (f=11.25), and the telescopic end state (f=29.64) in Numerical Example 2.

TABLE 7

| | Wide angle end | Intermediate focal length | Telescopic end |
|---|---|---|---|
| f | 4.60 | 11.25 | 29.64 |
| Fno | 3.55 | 4.67 | 6.09 |
| ω | 40.01 | 18.94 | 7.42 |

In the zoom lens 2, when the magnification is changed between the wide angle end state and the telescopic end state, the following intersurface distances change: the intersurface distance D6 between the first lens group GR1 and the second lens group GR2, the intersurface distance D12 between the second lens group GR2 and the aperture diaphragm S, the intersurface distance D19 between the third lens group GR3 and the fourth lens group GR4, and the intersurface distance D21 between the fourth lens group GR4 and the fifth lens group GR5. Table 8 shows the variable intersurface distances in the wide angle end state (f=4.60), the intermediate focal length state (f=11.25), and the telescopic end state (f=29.64) in Numerical Example 2.

TABLE 8

| | Wide angle end | Intermediate focal length | Telescopic end |
|---|---|---|---|
| f | 4.60 | 11.25 | 29.64 |
| D6 | 0.400 | 4.075 | 7.487 |
| D12 | 16.587 | 8.887 | 1.500 |
| D19 | 1.935 | 2.327 | 4.229 |
| D21 | 2.500 | 6.126 | 8.206 |

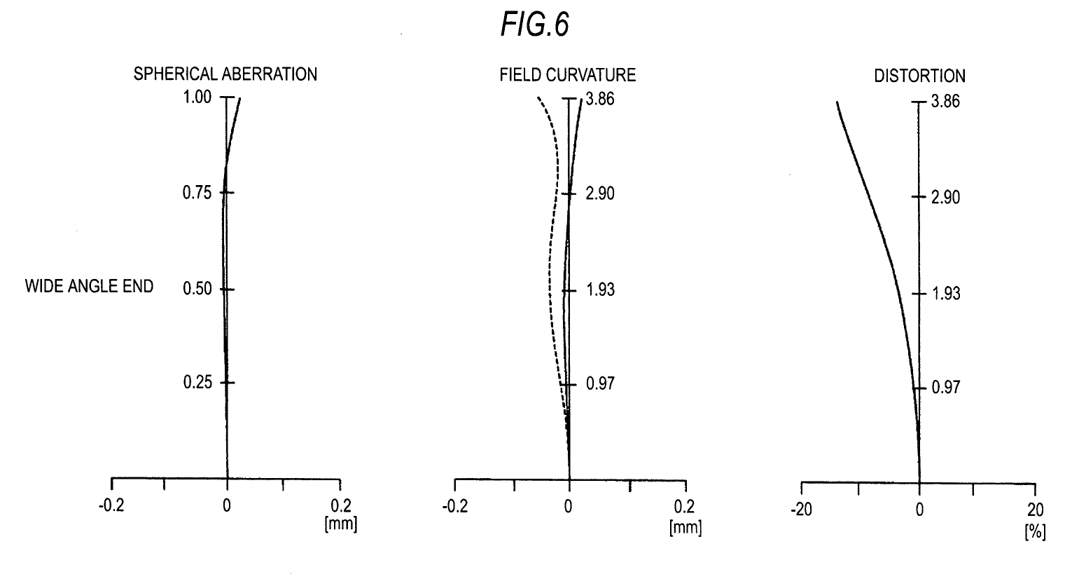

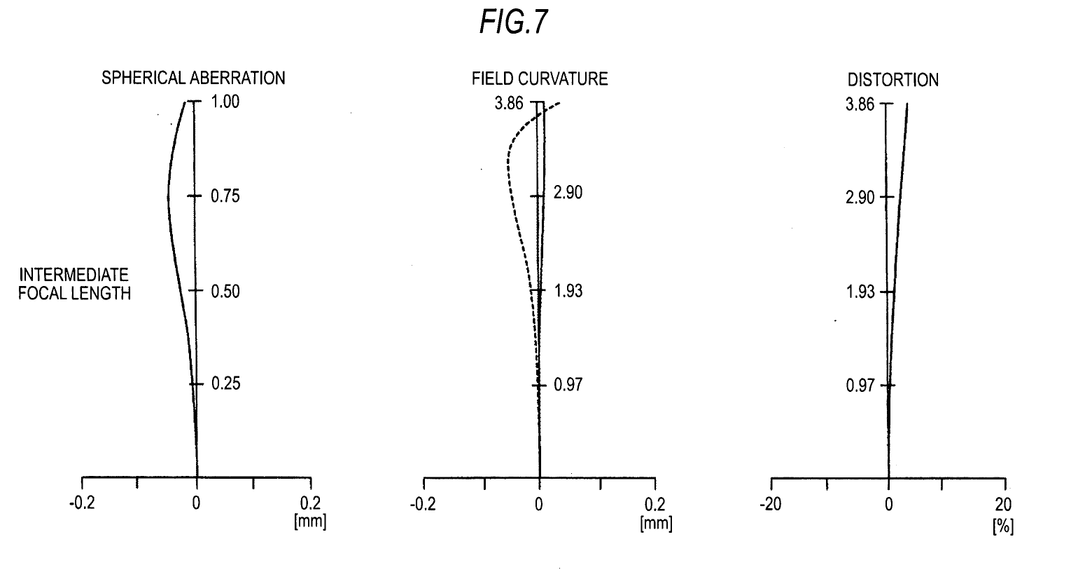

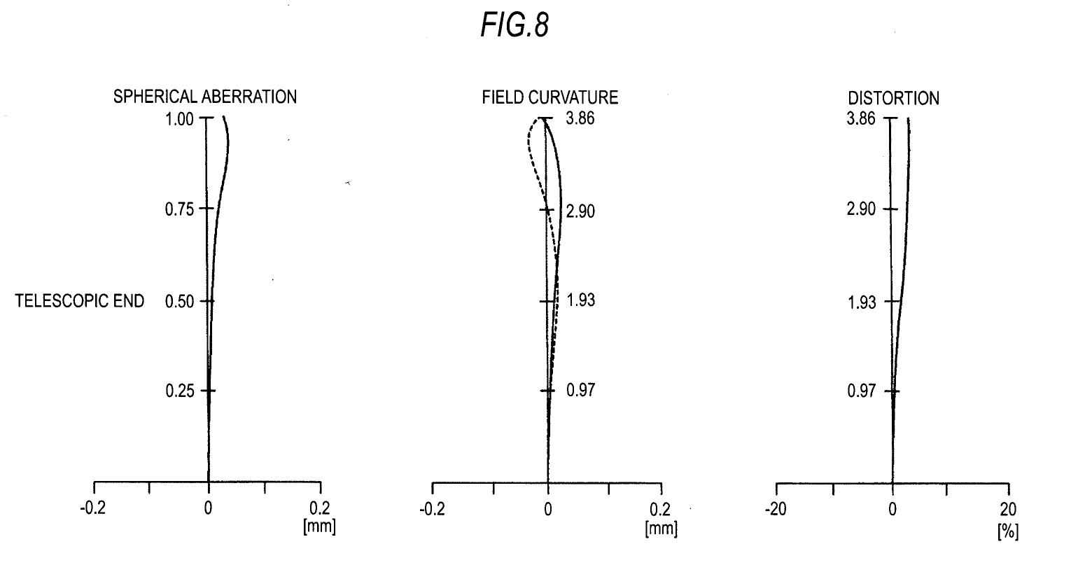

FIGS. 6 to 8 show aberration diagrams in a state in which an infinite point is brought into focus in Numerical Example 2. FIG. 6 shows aberration diagrams in the wide angle end state (f=4.60). FIG. 7 shows aberration diagrams in the intermediate focal length state (f=11.25). FIG. 8 shows aberration diagrams in the telescopic end state (f=29.64).

In the field curvature diagrams in FIGS. 6 to 8, solid lines represent values in the sagittal image plane, and broken lines represent values in the meridional image plane.

The aberration diagrams clearly show that the aberrations have been corrected in a satisfactory manner and excellent imaging performance has been achieved in Numerical Example 2.

### Third Example

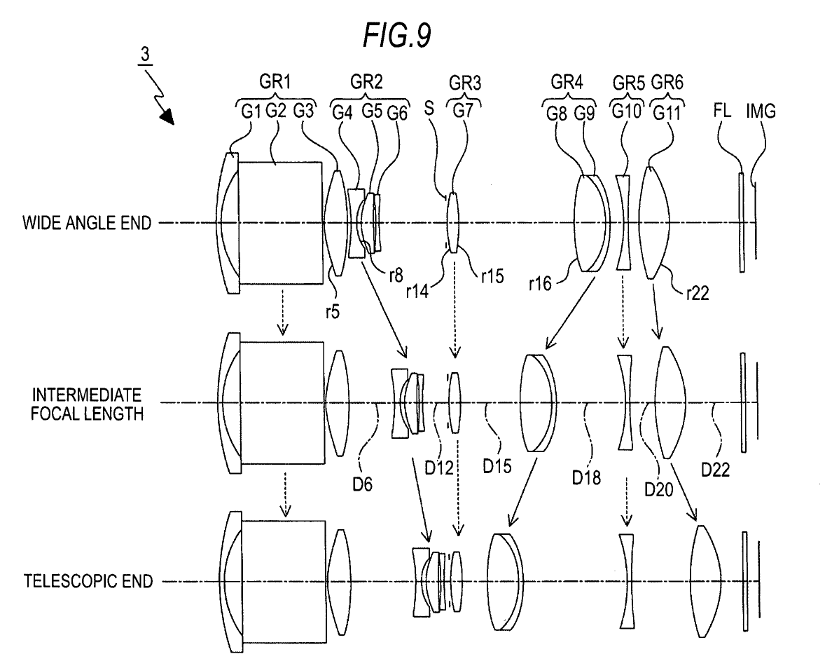

FIG. 9 shows the lens configuration of a zoom lens 3 in Third Example of the invention.

The zoom lens 3 includes a first lens group GR1 having positive refracting power, a second lens group GR2 having negative refracting power, a third lens group GR3 having positive refracting power, a fourth lens group GR4 having positive refracting power, a fifth lens group GR5 having negative refracting power, and a sixth lens group GR6 having positive refracting power arranged in this order from the object side toward the image side.

The zoom lens 3 has a variable power ratio of 5.5.

The first lens group GR1 is formed of a negative meniscus lens. G1 with a convex surface facing the object side, a rectangular prism G2 used as a reflection member for deflecting the optical path by 90 degrees, and a positive biconvex lens G3 arranged in this order from the object side toward the image side.

The second lens group GR2 is formed of a negative biconcave lens G4, a positive meniscus lens G5 with a convex surface facing the object side, and a negative biconcave lens G6 arranged in this order from the object side toward the image side.

The third lens group GR3 is formed of a positive biconvex lens G7.

The fourth lens group GR4 is formed of a doublet obtained by bonding a positive biconvex lens G8 to a negative meniscus lens G9 with a convex surface facing the image side.

The fifth lens group GR5 is formed of a negative biconcave lens G10.

The sixth lens group GR6 is formed of a positive biconvex lens G11.

A filter FL is disposed between the sixth lens group GR6 and an image plane IMG.

An aperture diaphragm S is disposed in the vicinity and on the objective side of the third lens group GR3.

In zooming operation, the second lens group GR2, the fourth lens group GR4, and the sixth lens group GR6 are movable lens groups, and the first lens group GR1, the third lens group GR3, and the fifth lens group GR5 are fixed lens groups.

Table 9 shows lens data in Numerical Example 3 in which specific values are substituted into the zoom lens 3 in Third Example.

TABLE 9

| Surface | | Radius of | Intersurface | Refractive | |
|---|---|---|---|---|---|
| number (r) | | curvature | distance | index | Abbe number |
| 1 | | 19.4707 | 0.500 | 1.92290 | 20.88 |
| 2 | | 8.0378 | 1.800 | | |
| 3 | | ∞ | 8.000 | 1.90370 | 31.31 |
| 4 | | ∞ | 0.100 | | |
| 5 | (ASP) | 9.7678 | 2.446 | 1.72840 | 54.08 |
| 6 | | −18.6357 | (D6) | | |
| 7 | | −14.2280 | 0.450 | 1.88300 | 40.80 |
| 8 | (ASP) | 3.7019 | 0.405 | | |
| 9 | | 6.9583 | 1.057 | 1.94600 | 17.98 |
| 10 | | 37.6182 | 0.292 | | |
| 11 | | −18.4922 | 0.400 | 1.88300 | 40.80 |
| 12 | | 75.6932 | (D12) | | |
| 13 | (aperture | ∞ | 0.100 | | |
| | diaphragm) | | | | |
| 14 | (ASP) | 11.9736 | 1.152 | 1.61880 | 63.85 |
| 15 | (ASP) | −15.6888 | (D15) | | |
| 16 | (ASP) | 15.6880 | 3.000 | 1.50180 | 79.87 |
| 17 | | −6.2223 | 0.400 | 1.84670 | 23.78 |
| 18 | | −8.6562 | (D18) | | |
| 19 | | −12.0223 | 0.400 | 1.90370 | 31.31 |
| 20 | | 42.4184 | (D20) | | |
| 21 | | 20.5542 | 3.000 | 1.49700 | 81.61 |
| 22 | (ASP) | −6.7884 | (D22) | | |
| 23 | | ∞ | 0.500 | 1.55670 | 58.56 |
| 24 | | ∞ | 1.000 | | |

In the zoom lens 3, the following surfaces are aspheric surfaces: the object-side surface (fifth surface) of the positive lens G3 in the first lens group GR1, the image-side surface (eighth surface) of the negative lens G4 in the second lens group GR2, both surfaces (fourteenth and fifteenth surfaces) of the positive lens G7 in the third lens group GR3, the object-side surface (sixteenth surface) of the positive lens G8 in the fourth lens group GR4, and the image-side surface (twenty second surface) of the positive lens G11 in the sixth lens group GR6. Table 10 shows the fourth, sixth, eighth, and tenth aspheric coefficients A, B, C, D and the conic constant κ of the aspheric surfaces in Numerical Example 3.

TABLE 10

| | κ | A | B | C | D |
|---|---|---|---|---|---|
| 5th surface | 0.00000E+00 | −2.06755E−04 | −1.20845E−06 | −1.04662E−08 | 1.35441E−10 |
| 8th surface | 0.00000E+00 | −3.22349E−03 | −8.47419E−05 | −7.70106E−06 | 0.00000E+00 |
| 14th surface | 0.00000E+00 | −2.33761E−04 | 2.04125E−06 | 4.31538E−09 | 0.00000E+00 |
| 15th surface | 0.00000E+00 | 4.20597E−05 | 2.43557E−06 | 0.00000E+00 | 0.00000E+00 |
| 16h surface | 0.00000E+00 | −3.00496E−04 | 3.36428E−06 | −8.37651E−08 | −2.66945E−10 |
| 22nd surface | 0.00000E+00 | 8.94152E−04 | −3.28997E−06 | 2.07960E−07 | 0.00000E+00 |

Table 11 shows the f-numbers Fno and half the angles of view ω in the wide angle end state (f=4.60), the intermediate focal length state (f=11.28), and the telescopic end state (f=25.52) in Numerical Example 3.

TABLE 11

| | Wide angle end | Intermediate focal length | Telescopic end |
|---|---|---|---|
| f | 4.60 | 11.28 | 25.52 |
| Fno | 3.52 | 3.89 | 5.45 |
| ω | 37.68 | 18.88 | 8.60 |

In the zoom lens 3, when the magnification is changed between the wide angle end state and the telescopic end state, the following intersurface distances change: the intersurface distance D6 between the first lens group GR1 and the second lens group GR2, the intersurface distance D12 between the second lens group GR2 and the aperture diaphragm S, the intersurface distance D15 between the third lens group GR3 and the fourth lens group GR4, the intersurface distance D18 between the fourth lens group GR4 and the fifth lens group GR5, the intersurface distance D20 between the fifth lens group GR5 and the sixth lens group GR6, and the intersurface distance D22 between the sixth lens group GR6 and the filter FL. Table 12 shows the variable intersurface distances in the wide angle end state (f=4.60), the intermediate focal length state (f=11.28), and the telescopic end state (f=25.52) in Numerical Example 3.

TABLE 12

| | Wide angle end | Intermediate focal length | Telescopic end |
|---|---|---|---|
| f | 4.60 | 11.28 | 25.52 |
| D6 | 0.400 | 4.555 | 6.550 |
| D12 | 6.553 | 2.400 | 0.400 |
| D15 | 11.166 | 5.935 | 2.600 |
| D18 | 1.500 | 6.729 | 10.069 |
| D20 | 1.000 | 2.417 | 5.679 |
| D22 | 6.680 | 5.263 | 2.000 |

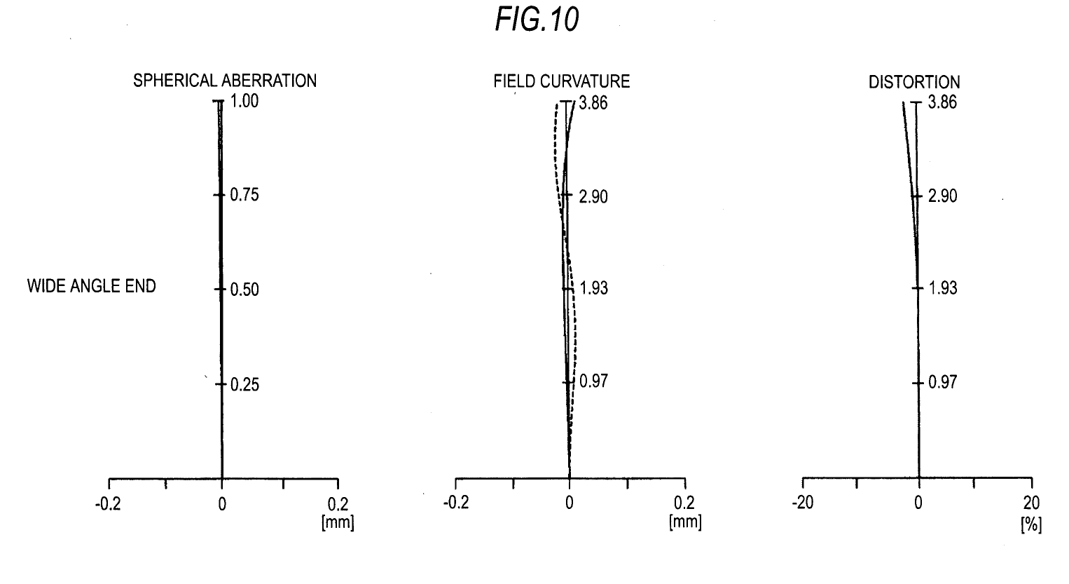

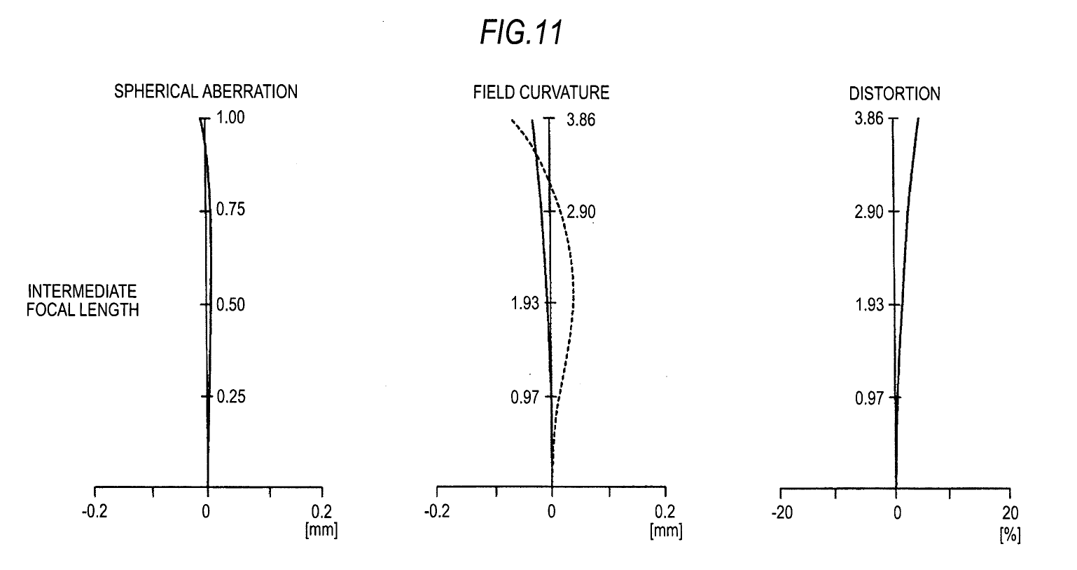

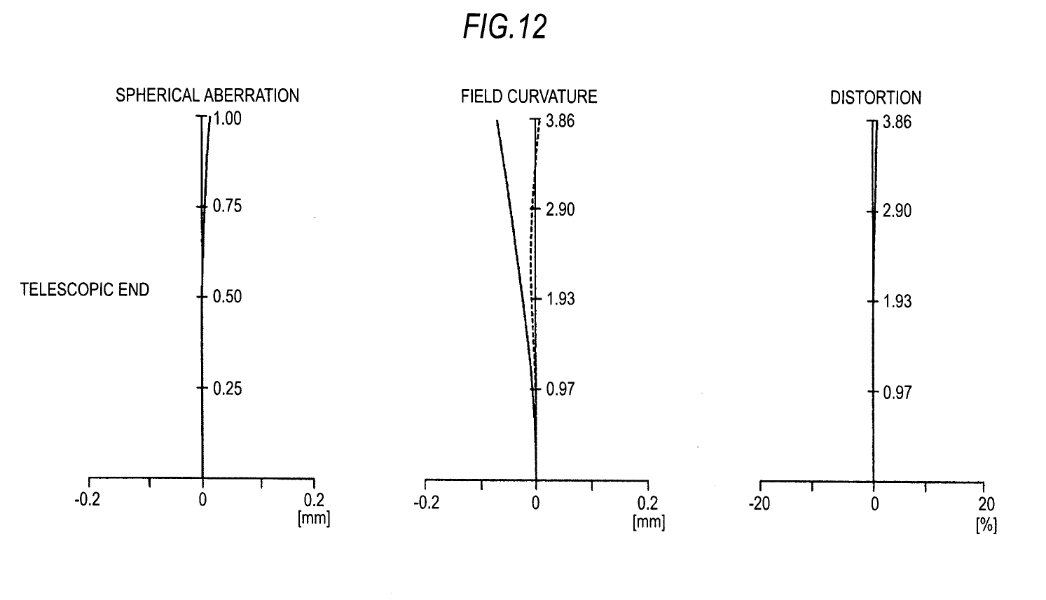

FIGS. 10 to 12 show aberration diagrams in a state in which an infinite point is brought into focus in Numerical Example 3. FIG. 10 shows aberration diagrams in the wide angle end state (f=4.60). FIG. 11 shows aberration diagrams in the intermediate focal length state (f=11.28). FIG. 12 shows aberration diagrams in the telescopic end state (f=25.52).

In the field curvature diagrams in FIGS. 10 to 12, solid lines represent values in the sagittal image plane, and broken lines represent values in the meridional image plane.

The aberration diagrams clearly show that the aberrations have been corrected in a satisfactory manner and excellent imaging performance has been achieved in Numerical Example 3.

### Fourth Example

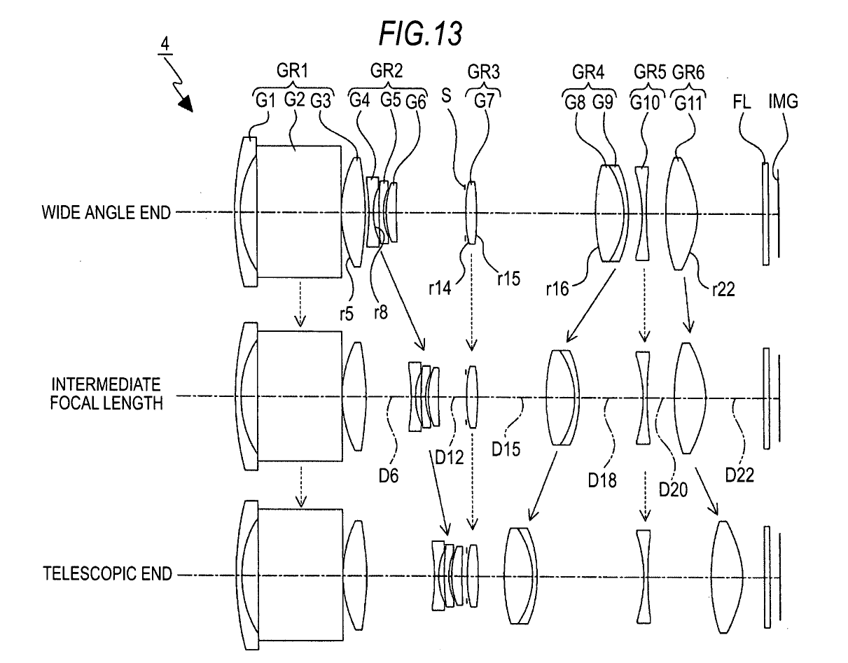

FIG. 13 shows the lens configuration of a zoom lens 4 in Fourth Example of the invention.

The zoom lens 4 includes a first lens group GR1 having positive refracting power, a second lens group GR2 having negative refracting power, a third lens group GR3 having positive refracting power, a fourth lens group GR4 having positive refracting power, a fifth lens group GR5 having negative refracting power, and a sixth lens group GR6 having positive refracting power arranged in this order from the object side toward the image side.

The zoom lens 4 has a variable power ratio of 5.5.

The first lens group GR1 is formed of a negative meniscus lens G1 with a convex surface facing the object side, a rectangular prism G2 used as a reflection member for deflecting the optical path by 90 degrees, and a positive biconvex lens G3 arranged in this order from the object side toward the image side.

The second lens group GR2 is formed of a negative biconcave lens G4, a negative meniscus lens G5 with a convex surface facing the object side, and a positive meniscus lens G6 with a convex surface facing the object side arranged in this order from the object side toward the image side.

The third lens group GR3 is formed of a positive biconvex lens G7.

The fourth lens group GR4 is formed of a doublet obtained by bonding a positive biconvex lens G8 to a negative meniscus lens G9 with a convex surface facing the image side.

The fifth lens group GR5 is formed of a negative biconcave lens G10.

The sixth lens group GR6 is formed of a positive biconvex lens G11.

A filter FL is disposed between the sixth lens group GR6 and an image plane IMG.

An aperture diaphragm S is disposed in the vicinity and on the objective side of the third lens group GR3.

In zooming operation, the second lens group GR2, the fourth lens group GR4, and the sixth lens group GR6 are movable lens groups, and the first lens group GR1, the third lens group GR3, and the fifth lens group GR5 are fixed lens groups.

Table 13 shows lens data in Numerical Example 4 in which specific values are substituted into the zoom lens 4 in Fourth Example.

TABLE 13

| Surface | | Radius of | Intersurface | Refractive | |
|---|---|---|---|---|---|
| number (r) | | curvature | distance | index | Abbe number |
| 1 | | 24.8147 | 0.500 | 1.92290 | 20.88 |
| 2 | | 9.0553 | 1.700 | | |
| 3 | | ∞ | 8.000 | 1.90370 | 31.31 |
| 4 | | ∞ | 0.100 | | |
| 5 | (ASP) | 9.4662 | 2.347 | 1.72840 | 54.08 |
| 6 | | −22.4508 | (D6) | | |
| 7 | | −15.3727 | 0.450 | 1.88300 | 40.79 |
| 8 | (ASP) | 5.2772 | 0.506 | | |
| 9 | | 43.7945 | 0.400 | 1.79110 | 44.07 |
| 10 | | 6.2669 | 0.193 | | |
| 11 | | 8.1608 | 0.882 | 1.94590 | 17.98 |
| 12 | | 32.1022 | (D12) | | |
| 13 | (aperture | ∞ | 0.100 | | |
| | diaphragm) | | | | |
| 14 | (ASP) | 10.5068 | 1.172 | 1.58310 | 59.46 |
| 15 | (ASP) | −16.9971 | (D15) | | |
| 16 | (ASP) | 12.3922 | 2.603 | 1.49770 | 80.36 |
| 17 | | −8.0558 | 0.400 | 1.80520 | 25.46 |
| 18 | | −10.8723 | (D18) | | |
| 19 | | −11.1493 | 0.400 | 1.84670 | 23.78 |
| 20 | | 34.9613 | (D20) | | |
| 21 | | 18.3775 | 2.982 | 1.49700 | 81.61 |
| 22 | (ASP) | −6.6678 | (D22) | | |
| 23 | | ∞ | 0.500 | 1.55670 | 58.56 |
| 24 | | ∞ | 1.000 | | |

In the zoom lens 4, the following surfaces are aspheric surfaces: the object-side surface (fifth surface) of the positive lens G3 in the first lens group GR1, the image-side surface (eighth surface) of the negative lens G4 in the second lens group GR2, both surfaces (fourteenth and fifteenth surfaces) of the positive lens G7 in the third lens group GR3, the object-side surface (sixteenth surface) of the positive lens G8 in the fourth lens group GR4, and the image-side surface (twenty second surface) of the positive lens G11 in the sixth lens group GR6. Table 14 shows the fourth, sixth, eighth, and tenth aspheric coefficients A, B, C, D and the conic constant κ of the aspheric surfaces in Numerical Example 4.

TABLE 14

| | κ | A | B | C | D |
|---|---|---|---|---|---|
| 5th surface | 0.00000E+00 | −2.03286E−04 | −1.22404E−06 | −1.09776E−08 | 3.13599E−11 |
| 8th surface | 0.00000E+00 | −2.26430E−03 | −2.68103E−05 | −3.99789E−07 | 0.00000E+00 |
| 14th surface | 0.00000E+00 | −4.45681E−04 | 9.34311E−07 | 1.64332E−09 | 0.00000E+00 |
| 15th surface | 0.00000E+00 | −1.44766E−04 | 1.19272E−06 | 0.00000E+00 | 0.00000E+00 |
| 16th surface | 0.00000E+00 | −3.01236E−04 | 2.38922E−06 | −6.84696E−08 | −3.49356E−10 |
| 22nd surface | 0.00000E+00 | 1.00813E−03 | −2.88666E−06 | 2.06606E−07 | 0.00000E+00 |

Table 15 shows the f-numbers Fno and half the angles of view ω in the wide angle end state (f=4.60), the intermediate focal length state (f=10.42), and the telescopic end state (f=25.52) in Numerical Example 4.

TABLE 15

| | Wide angle end | Intermediate focal length | Telescopic end |
|---|---|---|---|
| f | 4.60 | 10.42 | 25.52 |
| Fno | 3.53 | 3.78 | 5.60 |
| ω | 40.01 | 20.33 | 8.60 |

In the zoom lens 4, when the magnification is changed between the wide angle end state and the telescopic end state, the following intersurface distances change: the intersurface distance D6 between the first lens group GR1 and the second lens group GR2, the intersurface distance D12 between the second lens group GR2 and the aperture diaphragm S, the intersurface distance D15 between the third lens group GR3 and the fourth lens group GR4, the intersurface distance D18 between the fourth lens group GR4 and the fifth lens group GR5, the intersurface distance D20 between the fifth lens group GR5 and the sixth lens group GR6, and the intersurface distance D22 between the sixth lens group GR6 and the filter FL. Table 16 shows the variable intersurface distances in the wide angle end state (f=4.60), the intermediate focal length state (f=10.42), and the telescopic end state (f=25.52) in Numerical Example 4.

TABLE 16

| | Wide angle end | Intermediate focal length | Telescopic end |
|---|---|---|---|
| f | 4.60 | 10.42 | 25.52 |
| D6 | 0.400 | 4.484 | 6.675 |
| D12 | 6.662 | 2.563 | 0.400 |
| D15 | 11.355 | 6.711 | 2.600 |
| D18 | 1.500 | 6.146 | 10.259 |
| D20 | 1.838 | 2.662 | 6.133 |
| D22 | 6.302 | 5.466 | 2.000 |

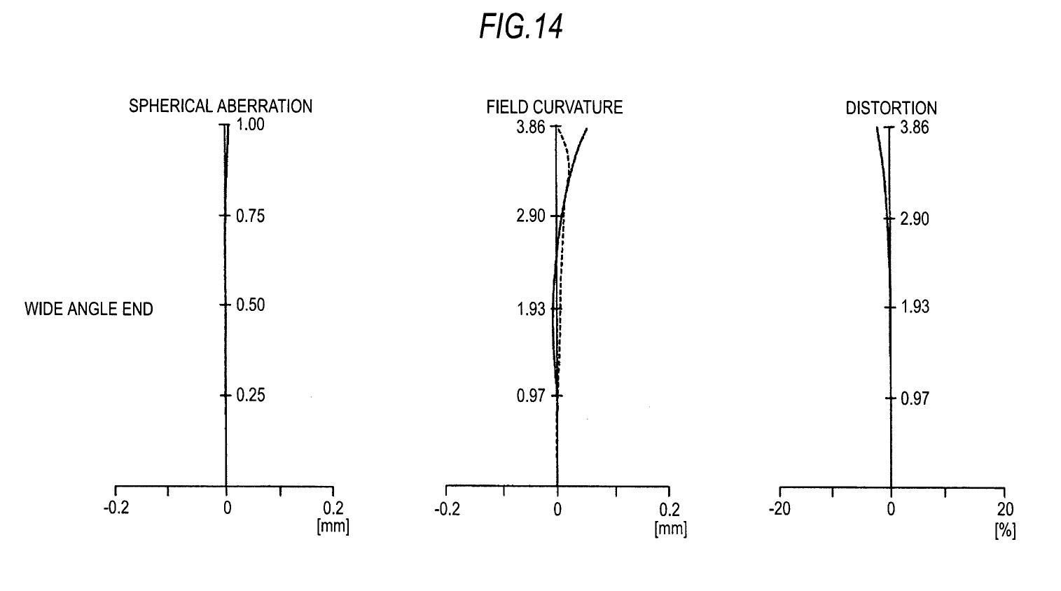

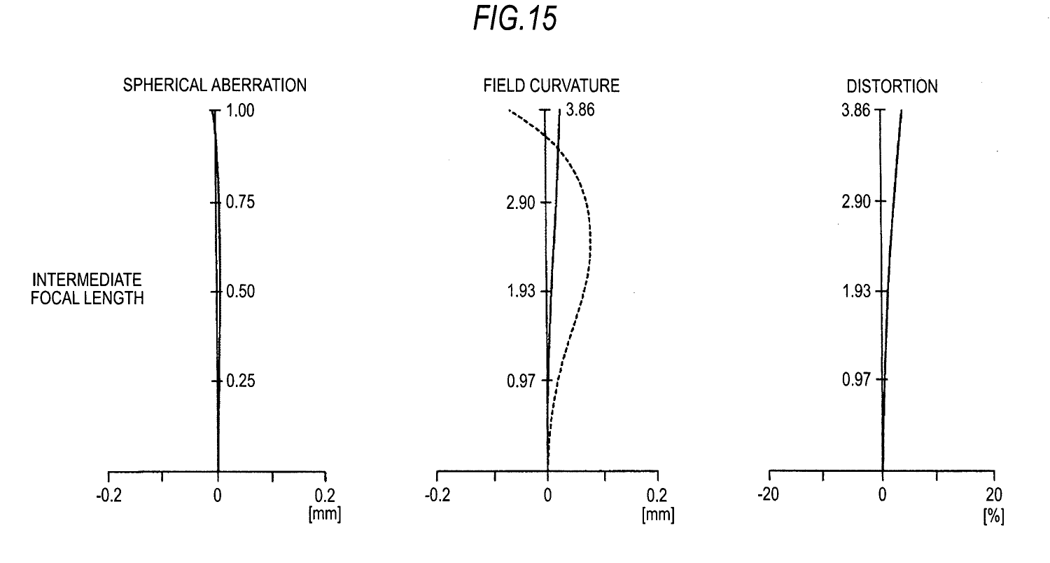

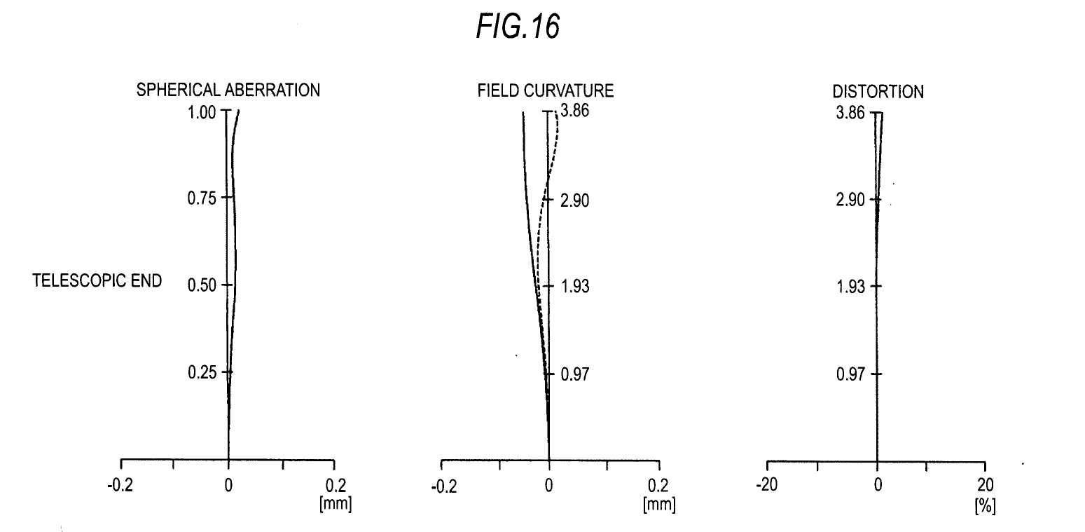

FIGS. 14 to 16 show aberration diagrams in a state in which an infinite point is brought into focus in Numerical Example 4. FIG. 14 shows aberration diagrams in the wide angle end state (f=4.60). FIG. 15 shows aberration diagrams in the intermediate focal length state (f=10.42). FIG. 16 shows aberration diagrams in the telescopic end state (f=25.52).

In the field curvature diagrams in FIGS. 14 to 16, solid lines represent values in the sagittal image plane, and broken lines represent values in the meridional image plane.

The aberration diagrams clearly show that the aberrations have been corrected in a satisfactory manner and excellent imaging performance has been achieved in Numerical Example 4.

### Fifth Example

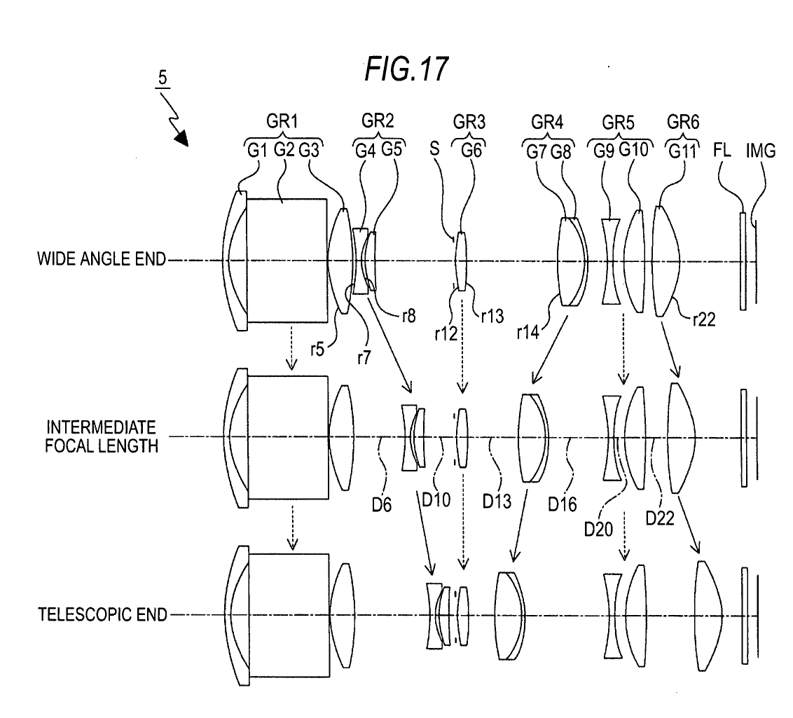

FIG. 17 shows the lens configuration of a zoom lens 5 in Fifth Example of the invention.

The zoom lens 5 includes a first lens group GR1 having positive refracting power, a second lens group GR2 having negative refracting power, a third lens group GR3 having positive refracting power, a fourth lens group GR4 having positive refracting power, a fifth lens group GR5 having negative refracting power, and a sixth lens group GR6 having positive refracting power arranged in this order from the object side toward the image side.

The zoom lens 5 has a variable power ratio of 5.5.

The first lens group GR1 is formed of a negative meniscus lens G1 with a convex surface facing the object side, a rectangular prism G2 used as a reflection member for deflecting the optical path by 90 degrees, and a positive biconvex lens G3 arranged in this order from the object side toward the image side.

The second lens group GR2 is formed of a negative biconcave lens G4 and a positive meniscus lens G5 with a convex surface facing the object side arranged in this order from the object side toward the image side.

The third lens group GR3 is formed of a positive biconvex lens G6.

The fourth lens group GR4 is formed of a doublet obtained by bonding a positive biconvex lens G7 to a negative meniscus lens G8 with a convex surface facing the image side.

The fifth lens group GR5 is formed of a negative biconcave lens G9 and a positive biconvex lens G10 arranged in this order from the object side toward the image side.

The sixth lens group GR6 is formed of a positive biconvex lens G11.

A filter FL is disposed between the sixth lens group GR6 and an image plane IMG.

An aperture diaphragm S is disposed in the vicinity and on the objective side of the third lens group GR3.

In zooming operation, the second lens group GR2, the fourth lens group GR4, and the sixth lens group GR6 are movable lens groups, and the first lens group GR1, the third lens group GR3, and the fifth lens group GR5 are fixed lens groups.

Table 17 shows lens data in Numerical Example 5 in which specific values are substituted into the zoom lens 5 in Fifth Example.

TABLE 17

| Surface | | Radius of | Intersurface | Refractive | |
|---|---|---|---|---|---|
| number (r) | | curvature | distance | index | Abbe number |
| 1 | | 18.5764 | 0.500 | 1.92290 | 20.88 |
| 2 | | 8.2541 | 1.800 | | |
| 3 | | ∞ | 8.000 | 1.90370 | 31.31 |
| 4 | | ∞ | 0.100 | | |
| 5 | (ASP) | 10.6461 | 2.299 | 1.72840 | 54.08 |
| 6 | | −19.9459 | (D6) | | |
| 7 | (ASP) | −8.0067 | 0.450 | 1.85130 | 40.10 |
| 8 | (ASP) | 3.6684 | 0.418 | | |
| 9 | | 7.2569 | 0.988 | 1.94590 | 17.98 |
| 10 | | 31.4191 | (D10) | | |
| 11 | (aperture | ∞ | 0.100 | | |
| | diaphragm) | | | | |
| 12 | (ASP) | 12.2419 | 1.127 | 1.58310 | 59.46 |
| 13 | (ASP) | −15.8218 | (D13) | | |
| 14 | (ASP) | 16.2540 | 2.622 | 1.49710 | 81.49 |
| 15 | | −6.0681 | 0.400 | 1.84670 | 23.78 |
| 16 | | −8.0129 | (D16) | | |
| 17 | | −13.3612 | 0.400 | 1.90370 | 31.31 |
| 18 | | 11.3150 | 1.000 | | |
| 19 | | 9.7076 | 1.956 | 1.51680 | 64.20 |
| 20 | | −779.3344 | (D20) | | |
| 21 | | 33.4208 | 2.529 | 1.49710 | 81.49 |
| 22 | (ASP) | −7.1065 | (D22) | | |
| 23 | | ∞ | 0.500 | 1.55670 | 58.56 |
| 24 | | ∞ | 1.000 | | |

In the zoom lens 5, the following surfaces are aspheric surfaces: the object-side surface (fifth surface) of the positive lens G3 in the first lens group GR1, both surface (seventh and eighth surfaces) of the negative lens G4 in the second lens group GR2, both surfaces (twelfth and thirteenth surfaces) of the positive lens G6 in the third lens group GR3, the object-side surface (fourteenth surface) of the positive lens G7 in the fourth lens group GR4, and the image-side surface (twenty second surface) of the positive lens G11 in the sixth lens group GR6. Table 18 shows the fourth, sixth, eighth, and tenth aspheric coefficients A, B, C, D and the conic constant κ of the aspheric surfaces in Numerical Example 5.

TABLE 18

| | κ | A | B | C | D |
|---|---|---|---|---|---|
| 5th surface | 0.00000E+00 | −1.46429E−04 | −4.85428E−07 | −1.69609E−08 | 2.38461E−10 |
| 7th surface | 0.00000E+00 | 4.78944E−04 | 6.36003E−06 | 6.41859E−09 | 0.00000E+00 |
| 8th surface | 0.00000E+00 | −4.14683E−03 | −4.14355E−05 | −9.30226E−06 | 0.00000E+00 |
| 12th surface | 0.00000E+00 | −1.90516E−04 | 1.48423E−06 | 1.88822E−08 | 0.00000E+00 |
| 13th surface | 0.00000E+00 | 7.92348E−05 | 3.69521E−07 | 0.00000E+00 | 0.00000E+00 |
| 14th surface | 0.00000E+00 | −4.20749E−04 | 2.80553E−06 | −1.36263E−07 | −3.17055E−10 |
| 22nd surface | 0.00000E+00 | 9.95302E−04 | −6.54998E−06 | 2.75696E−07 | 0.00000E+00 |

Table 19 shows the f-numbers Fno and half the angles of view coin the wide angle end state (f=4.60), the intermediate focal length state (f=11.28), and the telescopic end state (f=25.52) in Numerical Example 5.

TABLE 19

| | Wide angle end | Intermediate focal length | Telescopic end |
|---|---|---|---|
| f | 4.60 | 11.28 | 25.52 |
| Fno | 3.60 | 4.08 | 5.37 |
| ω | 37.89 | 18.90 | 8.60 |

In the zoom lens 5, when the magnification is changed between the wide angle end state and the telescopic end state, the following intersurface distances change: the intersurface distance D6 between the first lens group GR1 and the second lens group GR2, the intersurface distance D10 between the second lens group GR2 and the aperture diaphragm S, the intersurface distance D13 between the third lens group GR3 and the fourth lens group GR4, the intersurface distance D16 between the fourth lens group. GR4 and the fifth lens group GR5, the intersurface distance D20 between the fifth lens group GR5 and the sixth lens group GR6, and the intersurface distance D22 between the sixth lens group GR6 and the filter FL. Table 20 shows the variable intersurface distances in the wide angle end state (f=4.60), the intermediate focal length state (f=11.28), and the telescopic end state (f=25.52) in Numerical Example 5.

TABLE 20

| | Wide angle end | Intermediate focal length | Telescopic end |
|---|---|---|---|
| f | 4.60 | 11.28 | 25.52 |
| D6 | 0.400 | 4.959 | 7.499 |
| D10 | 7.682 | 3.111 | 0.578 |
| D13 | 9.057 | 5.049 | 2.600 |
| D16 | 2.000 | 6.018 | 8.461 |
| D20 | 1.000 | 2.322 | 4.973 |
| D22 | 5.973 | 4.649 | 2.000 |

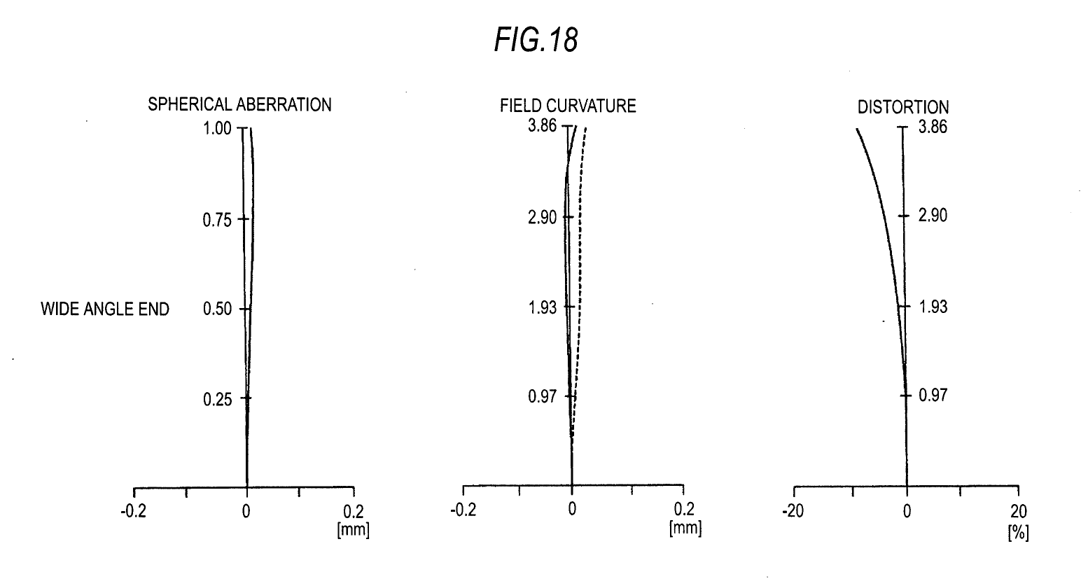

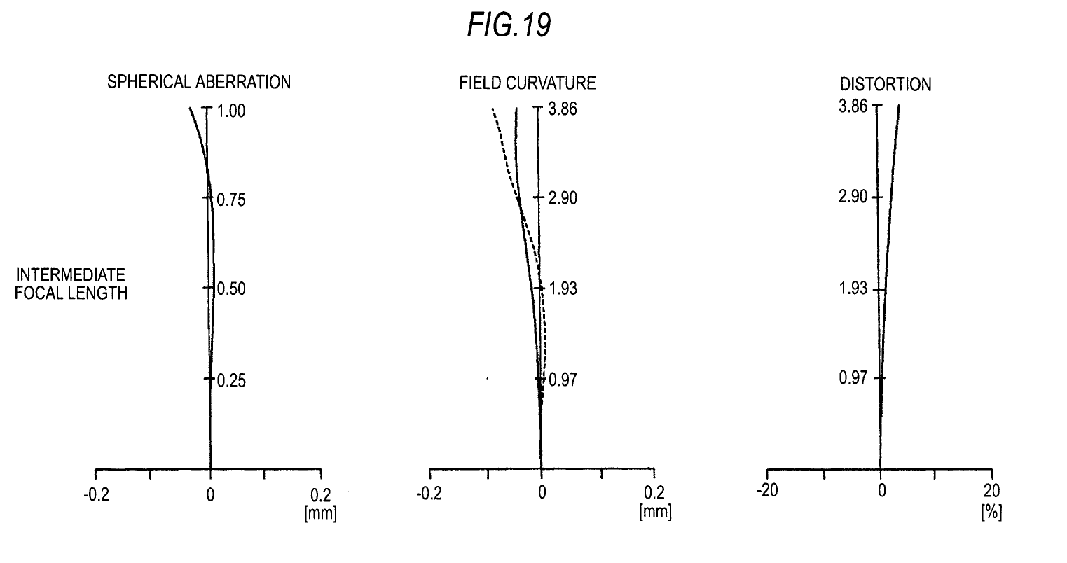

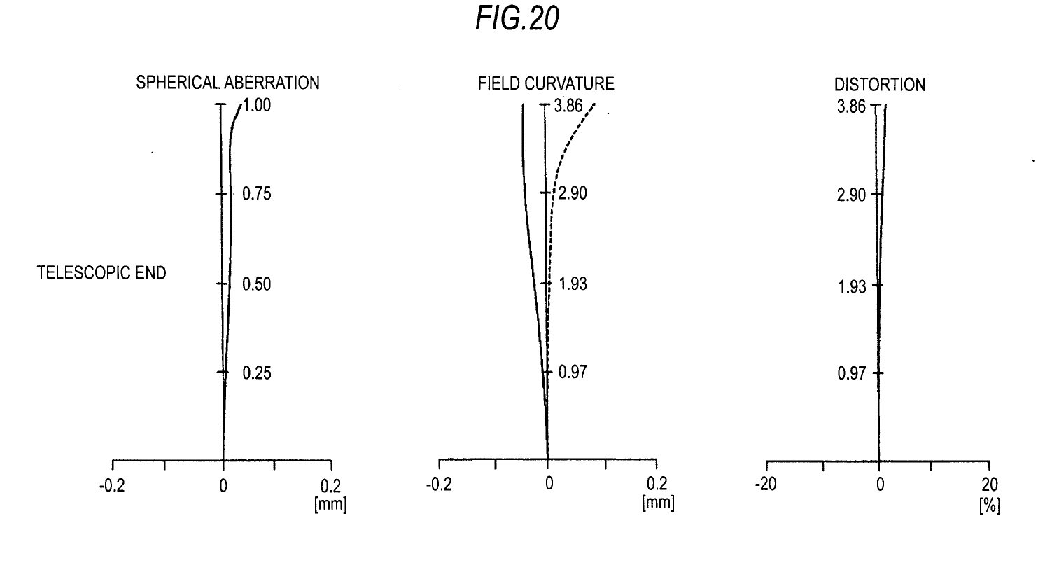

FIGS. 18 to 20 show aberration diagrams in a state in which an infinite point is brought into focus in Numerical Example 5. FIG. 18 shows aberration diagrams in the wide angle end state (f=4.60). FIG. 19 shows aberration diagrams in the intermediate focal length state (f=11.28). FIG. 20 shows aberration diagrams in the telescopic end state (f=25.52).

In the field curvature diagrams in FIGS. 18 to 20, solid lines represent values in the sagittal image plane, and broken lines represent values in the meridional image plane.

The aberration diagrams clearly show that the aberrations have been corrected in a satisfactory manner and excellent, imaging performance has been achieved in Numerical Example 5.

### Sixth Example

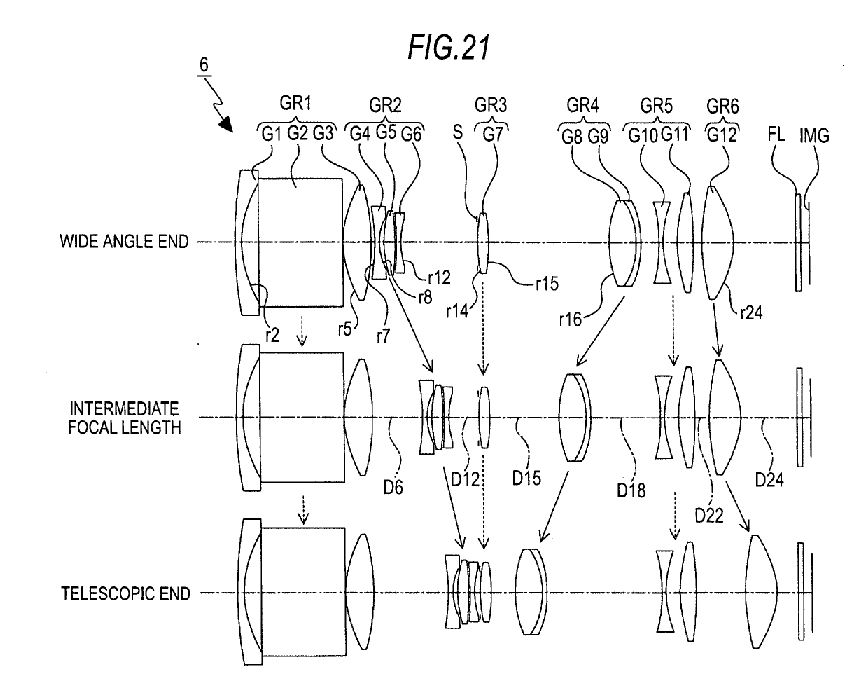

FIG. 21 shows the lens configuration of a zoom lens 6 in Sixth Example of the invention.

The zoom lens 6 includes a first lens group GR1 having positive refracting power, a second lens group GR2 having negative refracting power, a third lens group GR3 having positive refracting power, a fourth lens group GR4 having positive refracting power, a fifth lens group GR5 having negative refracting power, and a sixth lens group GR6 having positive refracting power arranged in this order from the object side toward the image side.

The zoom lens 6 has a variable power ratio of 7.4.

The first lens group GR1 is formed of a negative meniscus lens G1 with a convex surface facing the object side, a rectangular prism G2 used as a reflection member for deflecting the optical path by 90 degrees, and a positive biconvex lens G3 arranged in this order from the object side toward the image side.

The second lens group GR2 is formed of a negative biconcave lens G4, a positive biconvex lens G5, and a negative biconcave lens G6 arranged in this order from the object side toward the image side.

The third lens group GR3 is formed of a positive biconvex lens G7.

The fourth lens group GR4 is formed of a doublet obtained by bonding a positive biconvex lens G8 to a negative meniscus lens G9 with a convex surface facing the image side.

The fifth lens group GR5 is formed of a negative biconcave lens G10 and a positive biconvex lens G11 arranged in this order from the object side toward the image side.

The sixth lens group GR6 is formed of a positive biconvex lens G12.

A filter FL is disposed between the sixth lens group GR6 and an image plane IMG.

An aperture diaphragm S is disposed in the vicinity and on the objective side of the third lens group GR3.

In zooming operation, the second lens group GR2, the fourth lens group GR4, and the sixth lens group GR6 are movable lens groups, and the first lens group GR1, the third lens group GR3, and the fifth lens group GR5 are fixed lens groups.

Table 21 shows lens data in Numerical Example 6 in which specific values are substituted into the zoom lens 6 in Sixth Example.

TABLE 21

| Surface | | Radius of | Intersurface | Refractive | |
|---|---|---|---|---|---|
| number (r) | | curvature | distance | index | Abbe number |
| 1 | | 54.6784 | 0.500 | 1.92290 | 20.88 |
| 2 | (ASP) | 10.8661 | 1.800 | | |
| 3 | | ∞ | 8.314 | 1.90370 | 31.31 |
| 4 | | ∞ | 0.100 | | |
| 5 | (ASP) | 10.2696 | 2.717 | 1.72900 | 54.04 |
| 6 | | −18.9299 | (D6) | | |
| 7 | (ASP) | −13.6863 | 0.450 | 1.85130 | 40.10 |
| 8 | (ASP) | 4.6553 | 0.523 | | |
| 9 | | 10.4274 | 1.072 | 1.94590 | 17.98 |
| 10 | | −34.4761 | 0.101 | | |
| 11 | | −33.2720 | 0.400 | 1.88300 | 40.80 |
| 12 | (ASP) | 8.7240 | (D12) | | |
| 13 | (aperture | ∞ | 0.100 | | |
| | diaphragm) | | | | |
| 14 | (ASP) | 11.9405 | 1.112 | 1.59200 | 67.02 |
| 15 | (ASP) | −14.8958 | (D15) | | |
| 16 | (ASP) | 10.9084 | 2.512 | 1.49710 | 81.56 |
| 17 | | −7.3938 | 0.400 | 1.84670 | 23.78 |
| 18 | | −10.0707 | (D18) | | |
| 19 | | −12.6725 | 0.400 | 1.90370 | 31.31 |
| 20 | | 10.9057 | 1.314 | | |
| 21 | | 16.9415 | 1.512 | 1.51680 | 64.20 |
| 22 | | −31.3909 | (D22) | | |
| 23 | | 21.8531 | 3.000 | 1.49710 | 81.56 |
| 24 | (ASP) | −7.3575 | (D24) | | |
| 25 | | ∞ | 0.500 | 1.55670 | 58.56 |
| 26 | | ∞ | 1.000 | | |

In the zoom lens 6, the following surfaces are aspheric surfaces: the image-side surface (second surface) of the negative lens G1 in the first lens group GR1, the object-side surface (fifth surface) of the positive lens G3 in the first lens group GR1, both surfaces (seventh and eighth surfaces) of the negative lens G4 in the second lens group GR2, the image-side surface (twelfth surface) of the negative lens G6 in the second lens group GR2, both surfaces (fourteenth and fifteenth surfaces) of the positive lens G7 in the third lens group GR3, the object-side surface (sixteenth surface) of the positive lens G8 in the fourth lens group GR4, and the image-side surface (twenty fourth surface) of the positive lens G12 in the sixth lens group GR6. Table 22 shows the fourth, sixth, eighth, and tenth aspheric coefficients A, B, C, D and the conic constant κ of the aspheric surfaces in Numerical Example 6.

TABLE 22

| | κ | A | B | C | D |
|---|---|---|---|---|---|
| 2nd surface | 0.00000E+00 | −3.86820E−05 | 1.18952E−06 | 2.14546E−08 | −3.29656E−11 |
| 5th surface | 0.00000E+00 | −2.35626E−04 | −6.54449E−07 | 1.35924E−10 | −5.48842E−11 |
| 7th surface | 0.00000E+00 | 5.74895E−04 | −1.09269E−05 | −2.20414E−08 | 0.00000E+00 |
| 8th surface | 0.00000E+00 | −6.53856E−04 | 1.34712E−07 | 6.98626E−10 | 0.00000E+00 |
| 12th surface | 0.00000E+00 | −1.05427E−03 | −2.10247E−05 | −2.30224E−06 | 0.00000E+00 |
| 14th surface | 0.00000E+00 | −4.22202E−04 | −3.86730E−06 | −5.56719E−09 | 0.00000E+00 |
| 15th surface | 0.00000E+00 | −1.38809E−04 | −4.80069E−06 | 0.00000E+00 | 0.00000E+00 |
| 16th Surface | 0.00000E+00 | −2.99847E−04 | 4.78560E−07 | −3.75398E−08 | −5.58327E−11 |
| 24th surface | 0.00000E+00 | 8.04365E−04 | −7.12564E−06 | 1.66126E−07 | 0.00000E+00 |

Table 23 shows the f-numbers Fno and half the angles of view ω in the wide angle end state (f=4.37), the intermediate focal length state (f=11.52), and the telescopic end state (f=32.26) in Numerical Example 6.

TABLE 23

| | Wide angle end | Intermediate focal length | Telescopic end |
|---|---|---|---|
| f | 4.37 | 11.52 | 32.26 |
| Fno | 3.46 | 3.85 | 6.04 |
| ω | 39.32 | 18.53 | 6.82 |

In the zoom lens 6, when the magnification is changed between the wide angle end state and the telescopic end state, the following intersurface distances change: the intersurface distance D6 between the first lens group GR1 and the second lens group GR2, the intersurface distance D12 between the second lens group GR2 and the aperture diaphragm S, the intersurface distance D15 between the third lens group GR3 and the fourth lens group GR4, the intersurface distance D18 between the fourth lens group GR4 and the fifth lens group GR5, the intersurface distance D22 between the fifth lens group GR5 and the sixth lens group GR6, and the intersurface distance D24 between the sixth lens group GR6 and the filter FL. Table 24 shows the variable intersurface distances in the wide angle end state (f=4.37), the intermediate focal length state (f=11.52), and the telescopic end state (f=32.26) in Numerical Example 6.

TABLE 24

| | Wide angle end | Intermediate focal length | Telescopic end |
|---|---|---|---|
| f | 4.37 | 11.52 | 32.26 |
| D6 | 0.400 | 5.244 | 7.557 |
| D12 | 7.559 | 2.713 | 0.400 |
| D15 | 12.127 | 7.103 | 2.600 |
| D18 | 2.000 | 7.027 | 11.529 |
| D22 | 1.000 | 1.673 | 5.089 |
| D24 | 6.090 | 5.416 | 2.000 |

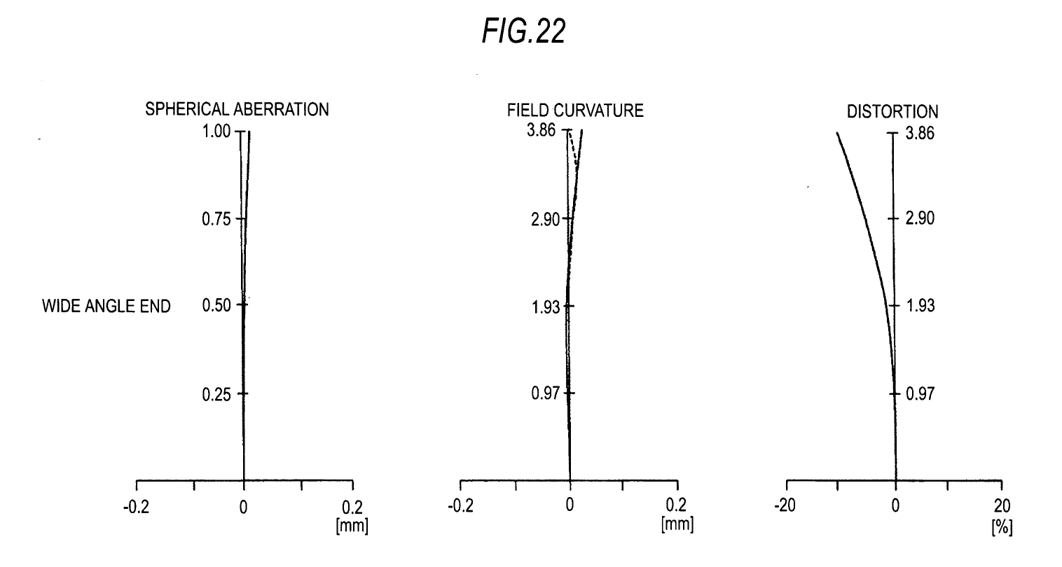

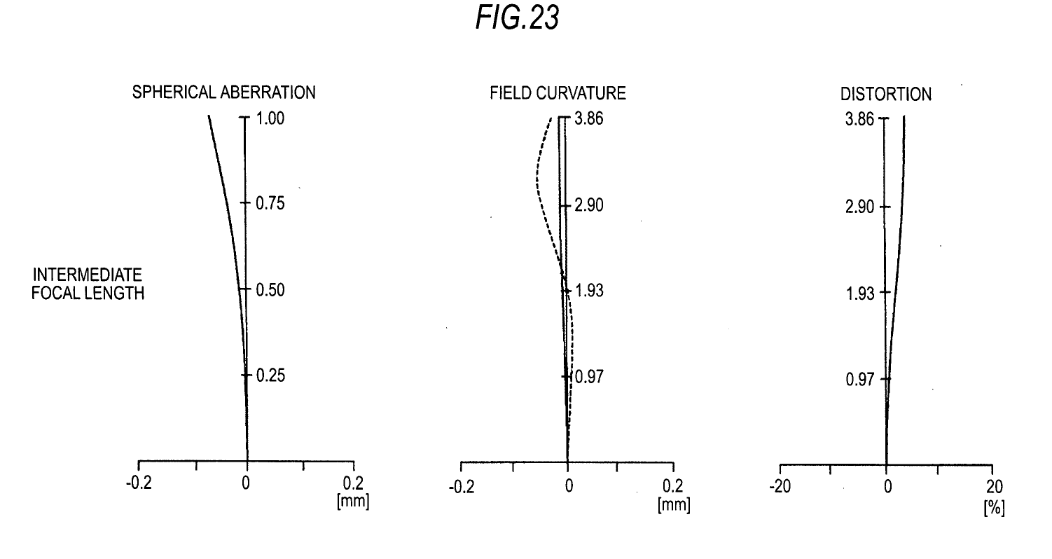

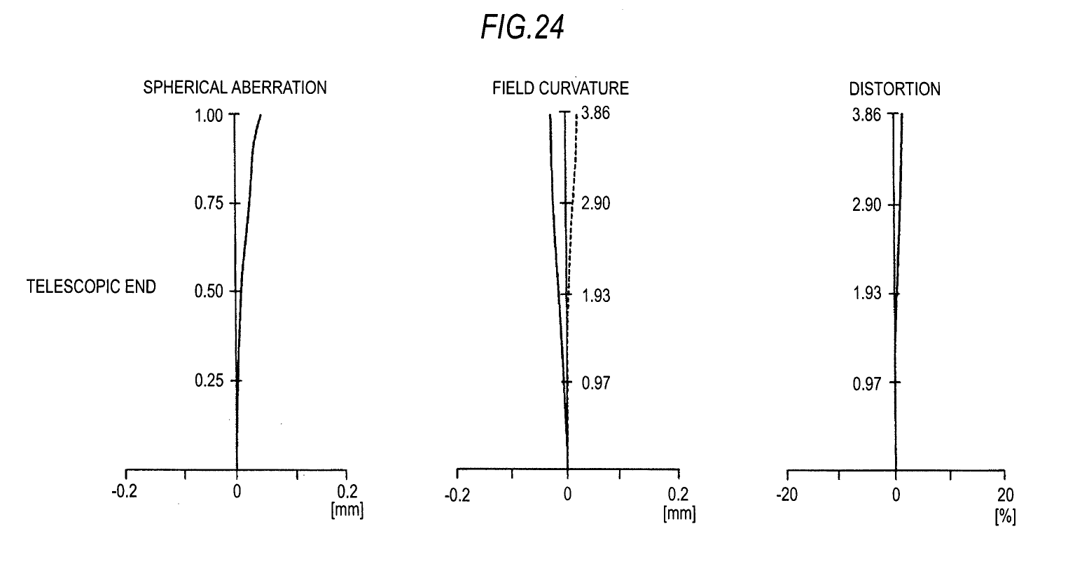

FIGS. 22 to 24 show aberration diagrams in a state in which an infinite point is brought into focus in Numerical Example 6. FIG. 22 shows aberration diagrams in the wide angle end state (f=4.37). FIG. 23 shows aberration diagrams in the intermediate focal length state (f=11.52). FIG. 24 shows aberration diagrams in the telescopic end state (f=32.26).

In the field curvature diagrams in FIGS. 22 to 24, solid lines represent values in the sagittal image plane, and broken lines represent values in the meridional image plane.

The aberration diagrams clearly show that the aberrations have been corrected in a satisfactory manner and excellent imaging performance has been achieved in Numerical Example 6.

### [Values in Conditional Equations for Zoom Lenses]

A description will be made of the values in the conditional equations for the zoom lenses according to the examples of the invention.

Table 25 shows the values in the conditional equations (1) to (6) for the zoom lenses 1 to 6.

TABLE 25

| | | Zoom | Zoom | Zoom |
|---|---|---|---|---|
| | | lens 1 | lens 2 | lens 3 |
| | R1B | −12.173 | −11.206 | −18.636 |
| | R21A | −9.084 | −7.423 | −14.228 |
| Conditional | (R1B + R21A)/ | 6.880 | 4.926 | 7.456 |
| equation (1) | (R1B − R21A) | | | |
| | R21B | 15.984 | 8.833 | 3.702 |
| | R22A | −126.848 | 65.959 | 6.958 |
| Conditional | (R21B + R22A)/ | −0.776 | −1.309 | −3.274 |
| equation (2) | (R21B − R22A) | | | |
| | D12t | 8.396 | 7.487 | 0.400 |
| | ft | 25.518 | 29.644 | 25.520 |
| Conditional | D12t/ft | 0.329 | 0.253 | 0.016 |
| equation (3) | | | | |
| | f21 | −6.435 | −4.651 | −3.269 |
| | fw | 4.600 | 4.600 | 4.600 |
| Conditional | \|f21/(fw × ft)^{1/2}\| | 0.594 | 0.398 | 0.302 |
| equation (4) | | | | |
| | f12 | 10.339 | 9.327 | 9.090 |
| Conditional | \|f12/(fw × ft)^{1/2}\| | 0.954 | 0.799 | 0.839 |
| equation (5) | | | | |
| | f11 | −10.526 | −11.183 | −14.984 |
| Conditional | \|f11/(fw × ft)^{1/2}\| | 0.971 | 0.958 | 1.383 |
| equation (6) | | | | |
| | | Zoom | Zoom | Zoom |
| | | lens 4 | lens 5 | lens 6 |
| | R1B | −22.451 | −19.946 | −18.930 |
| | R21A | −15.373 | −8.007 | −13.686 |
| Conditional | (R1B + R21A)/ | 5.344 | 2.341 | 6.220 |
| equation (1) | (R1B − R21A) | | | |
| | R21B | 5.277 | 3.668 | 4.655 |
| | R22A | 43.795 | 7.257 | 10.427 |
| Conditional | (R21B + R22A)/ | −1.274 | −3.045 | −2.613 |
| equation (2) | (R21B − R22A) | | | |
| | D12t | 0.400 | 0.578 | 7.557 |
| | ft | 25.520 | 25.520 | 32.260 |
| Conditional | D12t/ft | 0.016 | 0.023 | 0.234 |
| equation (3) | | | | |
| | f21 | −4.379 | −2.886 | −4.011 |
| | fw | 4.600 | 4.600 | 4.370 |
| Conditional | \|f21/(fw × ft)^{1/2}\| | 0.404 | 0.266 | 0.338 |
| equation (4) | | | | |
| | f12 | 9.393 | 9.798 | 9.465 |
| Conditional | \|f12/(fw × ft)^{1/2}\| | 0.867 | 0.904 | 0.797 |
| equation (5) | | | | |
| | f11 | −15.516 | −16.299 | −14.612 |
| Conditional | \|f11/(fw × ft)^{1/2}\| | 1.432 | 1.504 | 1.231 |
| equation (6) | | | | |

As clearly shown in Table 25, the zoom lenses 1 to 6 are configured to satisfy the conditional equations (1) to (6).

### [Configuration of Imaging Apparatus]

The zoom lens in an imaging apparatus according to an embodiment of the invention includes a first lens group including a reflection member that deflects the optical path by 90 degrees and having positive refracting power, a second lens group having negative refracting power, a third lens group having positive refracting power, and at least one lens group having negative refracting power and at least one lens group having positive refracting power disposed as a fourth lens group and the following lens groups. The first to third lens groups and the fourth and following lens groups are arranged in this order from the object side toward the image side.

The zoom lens in the imaging apparatus according to the embodiment of the invention further includes an aperture diaphragm disposed in the vicinity of the third lens group, and the lens groups described above are moved as follows when zooming is performed from a wide angle end state to a telescopic end state: The first lens group is fixed; the second lens group is moved toward the image side; and the fourth lens group is moved toward the object side.

The thus configured imaging apparatus according to the embodiment of the invention provides the following advantageous effects.

First, the aperture diaphragm is disposed in the vicinity of the third lens group, and the positive first lens group, the negative second lens group, the positive third lens group, and at least one lens group having negative refracting power and at least one lens group having positive refracting power as the fourth and following lens groups are disposed. At least one positive lens group and at least one negative lens group can therefore be disposed on the object and image sides of the aperture diaphragm, respectively. As a result, the arrangement of refracting power is nearly symmetric with respect to the aperture diaphragm, and negative distortion that tends to occur in the wide angle end state can be corrected in a satisfactory manner. A wider angle of view, for example, 75 degrees or greater, can therefore be achieved at the wide angle end.

Second, when zooming is performed from the wide angle end state to the telescopic end state, the second lens group is moved toward the image side and the fourth lens group is moved toward the object side, whereby the second and fourth lens groups can carry the burden of changing the magnification in a well balanced manner, and the amount of movement of each of the movable lens groups can be appropriately set. The size of the optical system can thus be reduced.

Third, the first lens group, which is fixed during zooming operation, provides waterproof and dustproof capabilities and allows a barrel configuration to be simplified.

Fourth, since the angle of view is large in the wide angle end state, off-axis light fluxes passing through the first and second lens groups are far away from the optical axis. The off-axis light fluxes passing through the first lens group can be made not too divergent by disposing the first and second lens groups close to each other.

Fifth, when the lens position setting is changed as the wide angle end state is changed toward the telescopic end state, the angle of view becomes smaller, and the off-axis light fluxes passing through the first and second lens groups shift toward the optical axis since the distance between the second lens group and the aperture diaphragm decreases. The change in height of the light fluxes passing through the first and second lens groups can be used to reduce the amount of change in off-axis aberration in a satisfactory manner that occurs when the lens position setting is changed.

The zoom lens in the imaging apparatus according to the embodiment of the invention satisfies the following conditional equation (1):

1<(R1B+R21A)/(R1B−R21A)<20 (1)

where R1B represents the radius of curvature of the surface closest to an image plane in the first lens group, and R21A represents the radius of curvature of the surface closest to an object plane in the second lens group.

The conditional equation (1) defines a preferable shape of an air lens between the first and second lens groups so that predetermined optical performance is provided.

When the value of the conditional equation (1) is smaller than the lower limit thereof, the radius of curvature of the surface closest to the image plane in the first lens group increases. In this case, distortion at the wide angle end increases in the negative direction, and it is difficult to correct astigmatism and other off-axis aberrations at the telescopic end in a satisfactory manner.

Conversely, when the value of the conditional equation (1) is greater than the upper limit thereof, the difference between the radius of curvature of the surface closest to the image plane in the first lens group and the radius of curvature of the surface closest to the object plane in the second lens group becomes too small, and it is difficult to correct astigmatism and other off-axis aberrations at the wide angle end and spherical and comatic aberrations at the telescopic end in a satisfactory manner.

Off-axis aberrations at the wide angle end and spherical and comatic aberrations at the telescopic end can be corrected in a satisfactory manner when the zoom lens satisfies the conditional equation (1).

The lower and upper limits of the conditional equation (1) are more preferably 2 and 10, respectively.

The thus configured zoom lens in the imaging apparatus according to the embodiment of the invention can provide an angle of view ranging from approximately 75 to 85 degrees in the wide angle end state, a variable power ratio ranging from approximately 5 to 8, and an f-number ranging from approximately 3.4 to 3.7 in the wide angle end state, whereby a compact size, a high variable power ratio, and high performance are achieved while a wide angle of view is ensured.

### [Embodiment of Imaging Apparatus]

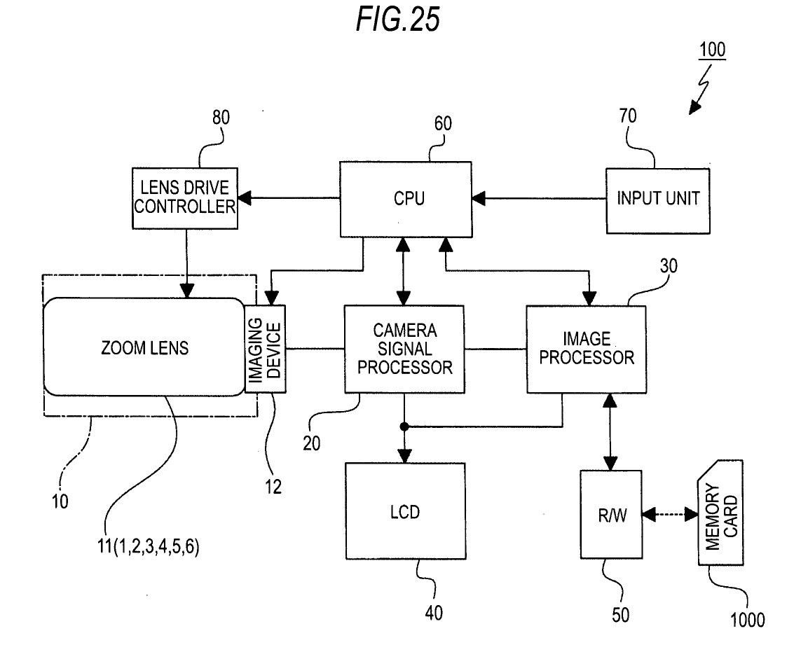

FIG. 25 shows a block diagram of a digital still camera as the imaging apparatus according to an embodiment of the invention.

An imaging apparatus (digital still camera) 100 includes a camera block 10 responsible for an imaging capability, a camera signal processor 20 that performs analog-digital conversion and other signal processing on a captured image signal, and an image processor 30 that records and reproduces the image signal. The imaging apparatus 100 further includes an LCD (Liquid Crystal Display) 40 that displays a captured image and other information, a R/W (reader/writer) 50 that writes and reads the image signal to and from a memory card 1000, and a CPU (Central Processing Unit) 60 that controls the entire imaging apparatus. The imaging apparatus 100 further includes an input unit 70 formed of a variety of switches and other components operated by the user as necessary, and a lens drive controller 80 that controls and drives lenses disposed in the camera block 10.

The camera block 10 is formed of an optical system including a zoom lens 11 (any of the zoom lenses 1, 2, 3, 4, 5, and 6 to which the invention is applied) and an imaging device 12, such as a CCD (Charge Coupled Device) and a CMOS (Complementary Metal-Oxide Semiconductor) device.

The camera single processor 20 converts an output signal from the imaging device 12 into a digital signal, performs noise removal and image quality correction, converts the digital signal into brightness/color difference signals, and performs other signal processing.

The image processor 30 performs compression encoding and decompression decoding on an image signal based on a predetermined image data format, performs data format conversion, such as resolution conversion, and performs other image processing.

The LCD 40 has a function of displaying a variety of data, such as user's operation through the input unit 70 and captured images.

The R/W 50 writes image data encoded by the image processor 30 to the memory card 1000 and reads image data recorded on the memory card 1000.

The CPU 60 functions as a control processor that controls circuit blocks provided in the imaging apparatus 100 and controls each of the circuit blocks based, for example, on an instruction input signal from the input unit 70.

The input unit 70 is formed, for example, of a shutter release button for shutter operation and a selection switch for selecting an action mode and outputs an instruction input signal according to user's operation to the CPU 60.

The lens drive controller 80 controls a motor or any other actuator (not shown) that drives lenses in the zoom lens 11 based on a control signal from the CPU 60.

The memory card 1000 is, for example, a semiconductor memory that can be attached and detached to and from a slot connected to the R/W 50.

The action of the imaging apparatus 100 will next be described.

In an imaging standby state, an image signal captured by the camera block 10 is outputted to the LCD 40 through the camera single processor 20 and displayed as a camera-through image on the LCD 40 under the control of the CPU 60. When a zooming instruction input signal is inputted from the input unit 70, the CPU 60 outputs a control signal to the lens drive controller 80, and a predetermined lens in the zoom lens 11 is moved under the control of the lens drive controller 80.

When a shutter (not shown) in the camera block 10 is operated in response to an instruction input signal from the input unit 70, the camera signal processor 20 outputs a captured image signal to the image processor 30, which performs compression encoding on the image signal and converts the encoded image signal into digital data expressed in a predetermined data format. The converted data is outputted to the R/W 50, which writes the data to the memory card 1000.

Focusing is carried out, for example, as follows: When the shutter release button in the input unit 50 is pressed halfway or fully pressed for recording (imaging), the lens drive controller 80 moves a predetermined lens in the zoom lens 11 based on a control signal from the CPU 60.

To reproduce image data recorded on the memory card 1000, predetermined image data is read from the memory card 1000 through the R/W 50 in response to user's operation performed through the input unit 70. The image processor 30 performs decompression decoding on the read image data, and an image signal to be reproduced is then outputted to the LCD 40 and displayed as a reproduced image.

The above embodiment has been described with reference to the case where the imaging apparatus is incorporated in a digital still camera, but the apparatus in which the imaging apparatus is incorporated is not limited to a digital still camera. The imaging apparatus can be widely used, for example, as a camera unit in a digital input/output apparatus, such as a digital video camcorder, a mobile phone equipped with a camera, and a PDA (Personal Digital Assistant) equipped with a camera.

The shapes and values of the components shown in the embodiments described above are presented only by way of example for implementing the invention and should not be used to construe the technical extent of the invention in a limited sense.

The present application contains subject matter related to that disclosed in Japanese Priority Patent Application JP 2010-024212 filed in the Japan Patent Office on Feb. 5, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A zoom lens comprising:
a first lens group including a reflection member that deflects an optical path by 90 degrees and having positive refracting power;
a second lens group having negative refracting power;
a third lens group having positive refracting power;
at least one lens group having negative refracting power and at least one lens group having positive refracting power disposed as a fourth lens group and the following lens groups,
the first to third lens groups and the fourth and following lens groups arranged in this order from an object side toward an image side; and
an aperture diaphragm disposed in the vicinity of the third lens group,
wherein when zooming is performed from a wide angle end state to a telescopic end state, the first lens group is fixed, the second lens group is moved toward the image side, and the fourth lens group is moved toward the object side, and
the zoom lens satisfies the following conditional equation (1)
1<(R1B+R21A)/(R1B−R21A)<20 (1)
where R1B represents the radius of curvature of a surface closest to an image plane in the first lens group, and R21A represents the radius of curvature of a surface closest to an object plane in the second lens group.

2. The zoom lens according to claim 1,
wherein the first lens group is formed of a negative meniscus lens with a convex surface facing the object side, the reflection member, and a positive lens arranged in this order from the object side toward the image side.

3. The zoom lens according to claim 1,
wherein the second lens group is formed of a first portion group and a second portion group arranged in this order from the object side toward the image side,
the first portion group is formed of a negative biconcave lens, and
the second portion group is formed of one or two lenses including a positive lens.

4. The zoom lens according to claim 3,
wherein the zoom lens satisfies the following conditional equation (2)
−10<(R21B+R22A)/(R21B−R22A)<0 (2)
where R21B represents the radius of curvature of a surface closest to the image plane in the first portion group in the second lens group, and R22A represents the radius of curvature of a surface closest to the object plane in the second portion group in the second lens group.

5. The zoom lens according to claim 1,
wherein the zoom lens satisfies the following conditional equation (3)
0<D12t/ft<0.4 (3)
where D12t represents the distance from the apex of a surface closest to the image plane in the first lens group to the apex of a surface closest to the object plane in the second lens group at the telescopic end, and ft represents the focal length of the whole lens system at the telescopic end.

6. The zoom lens according to claim 1,
wherein the lens group disposed in a position closest to the image plane has positive refracting power.

7. The zoom lens according to claim 1,
wherein a biconvex lens is disposed in the third lens group in a position closest to the object plane.

8. The zoom lens according to claim 1,
wherein the fourth lens group is formed of a single lens or a doublet.

9. The zoom lens according to claim 1,
wherein one of the lens groups downstream of the third lens group but other than the fourth lens group is moved in the optical axis direction during zooming operation.

10. The zoom lens according to claim 3,
wherein the zoom lens satisfies the following conditional equation (4)
0.1<|f21/(fw×ft)^{1/2}|<1.5 (4)
where f21 represents the focal length of the first portion group in the second lens group, fw represents the focal length of the whole lens system at the wide angle end, and ft represents the focal length of the whole lens system at the telescopic end.

11. The zoom lens according to claim 2,
wherein the zoom lens satisfies the following conditional equation (5)
0.1<|f12/(fw×ft)^{1/2}|<1.5 (5)
where f12 represents the focal length of the positive lens disposed on the image side of the reflection member in the first lens group, fw represents the focal length of the whole lens system at the wide angle end, and ft represents the focal length of the whole lens system at the telescopic end.

12. The zoom lens according to claim 2,
wherein the zoom lens satisfies the following conditional equation (6)
0.5<|f11/(fw×ft)^{1/2}1<2.0 (6)
where f11 represents the focal length of the negative meniscus lens disposed on the object side of the reflection member in the first lens group, fw represents the focal length of the whole lens system at the wide angle end, and ft represents the focal length of the whole lens system at the telescopic end.

13. An imaging apparatus comprising:
a zoom lens; and
an imaging device that converts an optical image formed by the zoom lens into an electric signal,
wherein the zoom lens includes a first lens group including a reflection member that deflects an optical path by 90 degrees and having positive refracting power, a second lens group having negative refracting power, a third lens group having positive refracting power, at least one lens group having negative refracting power and at least one lens group having positive refracting power disposed as a fourth lens group and the following lens groups, the first to third lens groups and the fourth and following lens groups arranged in this order from an object side toward an image side,
the zoom lens further includes an aperture diaphragm disposed in the vicinity of the third lens group,
when zooming is performed from a wide angle end state to a telescopic end state, the first lens group is fixed, the second lens group is moved toward the image side, and the fourth lens group is moved toward the object side, and
the zoom lens satisfies the following conditional equation (1)
1<(R1B+R21A)/(R1B−R21A)<20 (1)
where R1B represents the radius of curvature of a surface closest to an image plane in the first lens group, and R21A represents the radius of curvature of a surface closest to an object plane in the second lens group.
